(19) United States
(12) Patent Application Publication
(10) Pub. No.: US 2024/0311396 A1
(43) Pub. Date: Sep. 19, 2024

(54) INFORMATION PROCESSING APPARATUS, INFORMATION PROCESSING SYSTEM, INFORMATION PROCESSING METHOD, AND NON-TRANSITORY RECORDING MEDIUM

(71) Applicant: Keisuke Iwasa, TOKYO (JP)

(72) Inventor: Keisuke Iwasa, TOKYO (JP)

(73) Assignee: Ricoh Company, Ltd., Tokyo (JP)

(21) Appl. No.: 18/581,785

(22) Filed: Feb. 20, 2024

(30) Foreign Application Priority Data
Mar. 17, 2023 (JP) 2023-043554

(51) Int. Cl. G06F 16/28

(52) U.S. Cl. CPC G06F 16/285

(57) ABSTRACT

An information processing apparatus includes circuitry to select one or more of a plurality of management units as candidates for a registration destination in which first data is to be registered, based on a feature amount of the first data and feature amounts of data belonging to each of the plurality of management units, and output information indicating the candidates for the registration destination.

### CROSS-REFERENCE TO RELATED APPLICATIONS

This patent application is based on and claims priority pursuant to 35 U.S.C. § 119(a) to Japanese Patent Application No. 2023-043554, filed on Mar. 17, 2023, in the Japan Patent Office, the entire disclosure of which is hereby incorporated by reference herein.

### BACKGROUND

### Technical Field

The present disclosure relates to an information processing apparatus, an information processing system, an information processing method, and a non-transitory recording medium.

### Related Art

Various types of data have been conventionally managed and organized based on the customs of organizations or the discretion of individuals. For example, the target pieces of data are managed in group using folders in which the target pieces of data are classified and managed in a state where the target pieces of data are easy for an operator to use. The operator can easily specify the location of a piece of data to be used (for example, information or knowledge to be collected by an area of responsibility or interest of the operator), and as a result, the efficiency of work is increased.

### SUMMARY

In one aspect, an information processing apparatus includes circuitry to select one or more of a plurality of management units as candidates for a registration destination in which first data is to be registered, based on a feature amount of the first data and feature amounts of data belonging to each of the plurality of management units, and output information indicating the candidates for the registration destination.

In another aspect, an information processing system includes circuitry to select one or more of a plurality of management units as candidates for a registration destination in which first data is to be registered, based on a feature amount of the first data and feature amounts of data belonging to each of the plurality of management units, and output information indicating the candidates for the registration destination.

In another aspect, an information processing method includes selecting one or more of a plurality of management units as candidates for a registration destination in which first data is to be registered based on a feature amount of the first data and feature amounts of data belonging to each of the plurality of management units, and outputting information indicating the candidates for the registration destination.

In another aspect, a non-transitory recording medium storing a plurality of program codes which, when executed by one or more processors, causes the one or more processors to perform the method described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information collection system according to the first embodiment of the present disclosure;

FIG. 2 is a block diagram illustrating a hardware configuration of an information collection apparatus according to the first embodiment of the present disclosure;

FIG. 3 is a block diagram illustrating a functional configuration of an information collection system according to the first embodiment of the present disclosure;

FIG. 4 is a flowchart of the processing executed by an information collection system according to the first embodiment of the present disclosure;

FIG. 5 is a diagram illustrating a collection condition input screen according to an embodiment of the present disclosure;

FIG. 6 is a diagram illustrating a structure of a document vector storage unit according to an embodiment of the present disclosure;

FIG. 7 is a diagram illustrating a structure of a document information storage unit according to an embodiment of the present disclosure;

FIG. 8 is a diagram illustrating a sorting result of pieces of document information according to an embodiment of the present disclosure;

FIG. 9 is a diagram illustrating display of a search result screen according to an embodiment of the present disclosure;

FIG. 10 is a diagram illustrating display of a registration destination inquiry screen according to an embodiment of the present disclosure;

FIG. 11 is a diagram illustrating display of a workspace generation method inquiry screen according to an embodiment of the present disclosure;

FIG. 12 is a diagram illustrating a structure of a workspace storage unit according to an embodiment of the present disclosure;

FIG. 13 is a diagram illustrating display of a workspace detail screen according to an embodiment of the present disclosure;

FIG. 14 is a flowchart of the processing for registration in an existing workspace according to an embodiment of the present disclosure;

FIG. 15 is a diagram illustrating display of a workspace extraction method inquiry screen according to an embodiment of the present disclosure;

FIG. 16 is a diagram illustrating display of a workspace search screen according to an embodiment of the present disclosure;

FIG. 17 is a diagram illustrating display of a search result of searching for a workspace according to an embodiment of the present disclosure;

FIG. 18 is a flowchart of the processing to search for a relevant workspace according to the first embodiment of the present disclosure;

FIG. 19 is a flowchart of the processing to calculate the degree of relevance for each group according to an embodiment of the present disclosure;

FIG. 20 is a diagram illustrating term frequency-inverse document frequency (TF-IDF) of two pieces of document data according to an embodiment of the present disclosure;

FIG. 21 is a diagram illustrating display of a relevant workspace list screen according to an embodiment of the present disclosure;

FIG. 22 is a diagram illustrating display of a preview screen in the case of registration in an existing workspace according to an embodiment of the present disclosure;

FIG. 23 is a diagram illustrating display of a workspace edit screen in the initial state when an existing workspace is a registration destination according to an embodiment of the present disclosure;

FIG. 24 is a diagram illustrating display of a workspace edit screen for receiving selection of an assignment method to a group according to an embodiment of the present disclosure;

FIG. 25 is a diagram illustrating display of a workspace edit screen presenting an assignment state for all pieces of document information to be registered based on a proposal, according to an embodiment of the present disclosure;

FIG. 26 is a diagram illustrating display of a workspace edit screen presenting a proposal of an assignment destination for one piece of document information, according to an embodiment of the present disclosure;

FIG. 27 is a diagram illustrating display of a workspace edit screen updated when an option corresponding to a relevant group is selected, according to an embodiment of the present disclosure;

FIG. 28 is a diagram illustrating display of a workspace edit screen updated when an option corresponding to a new group is selected, according to an embodiment of the present disclosure;

FIG. 29 is a diagram illustrating a case in which an assignment destination for document information to be registered is determined by an operator as desired, according to an embodiment of the present disclosure;

FIG. 30 is a flowchart of the processing for registration in a new workspace that is empty, according to an embodiment of the present disclosure;

FIG. 31 is a diagram illustrating display of a workspace edit screen in the initial state in the case of registration in a new workspace according to an embodiment of the present disclosure;

FIG. 32 is a diagram illustrating display of a workspace edit screen presenting a result of the first division into groups according to an embodiment of the present disclosure;

FIG. 33 is a diagram illustrating display of a workspace edit screen presenting a result of the second division into groups according to an embodiment of the present disclosure;

FIG. 34 is a diagram illustrating a case in which an assignment destination for document information to be registered is determined by an operator as desired when a registration destination is a new workspace that is empty, according to an embodiment of the present disclosure;

FIG. 35 is a flowchart of the processing for registration in a new workspace in which a group structure of an existing workspace is copied, according to an embodiment of the present disclosure;

FIG. 36 is a diagram illustrating display of a preview screen in the case of registration in a new workspace in which a group structure of an existing workspace is copied, according to an embodiment of the present disclosure;

FIG. 37 is a diagram illustrating display of a workspace edit screen in the initial state when a new workspace in which a group structure of an existing workspace is copied is a registration destination, according to an embodiment of the present disclosure;

FIG. 38 is a flowchart of the processing for registration in a new workspace in which all of an existing workspace is copied, according to an embodiment of the present disclosure;

FIG. 39 is a diagram illustrating display of a preview screen in the case of registration in a new workspace in which all of an existing workspace is copied, according to an embodiment of the present disclosure;

FIG. 40 is a diagram illustrating display of a workspace edit screen in the initial state when a new workspace in which all of an existing workspace is copied is a registration destination, according to an embodiment of the present disclosure;

FIG. 41 is a diagram illustrating a configuration of an information collection system according to the second embodiment of the present disclosure;

FIG. 42 is a block diagram illustrating a functional configuration of an information collection system according to the second embodiment of the present disclosure;

FIG. 43 is a flowchart of the processing to search for a relevant workspace according to the second embodiment of the present disclosure;

FIG. 44 is a diagram illustrating a structure of an employee information storage unit according to an embodiment of the present disclosure; and

FIG. 45 is a diagram illustrating a structure of a conference information storage unit according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

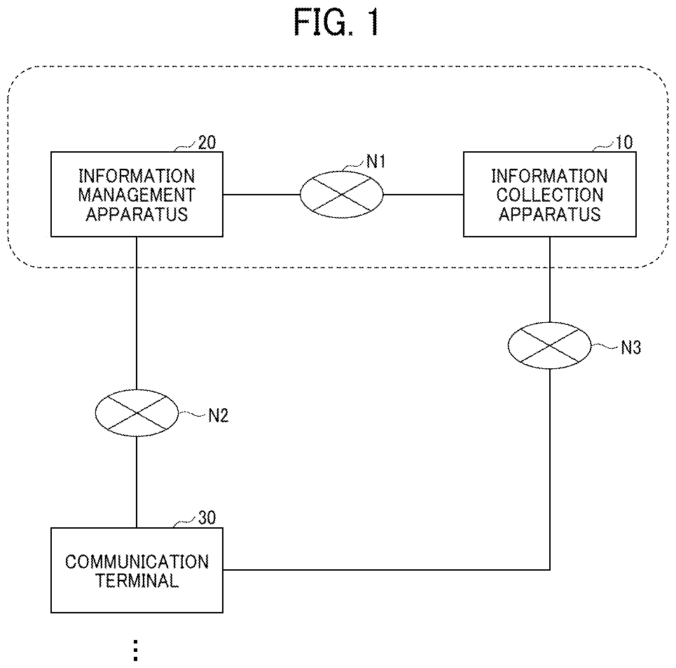

Embodiments of the present disclosure are described below with reference to the drawings. FIG. 1 is a diagram illustrating a configuration of an information collection system according to the first embodiment of the present disclosure. As illustrated in FIG. 1, the information collection system (information processing system) includes an information management apparatus 20, an information collection apparatus 10, and one or more communication terminals 30. Any one of the communication terminals 30 is referred to as a communication terminal 30 in the following description. The information collection apparatus 10 is connected to the information management apparatus 20 via a network N1. The communication terminal 30 is connected to the information management apparatus 20 via a network N2 and to the information collection apparatus 10 via a network N3.

The communication terminal 30 is a communication terminal used by an operator who collects (accesses), for example, certain information. For example, a personal computer (PC), a tablet terminal, or a smartphone may be used as the communication terminal 30. In the present embodiment, document information is given by way of example as the type of information collected by the operator.

The document information refers to information including attribute information or bibliographic information relating to electronic data (referred to as “document data” in the following description) in which a documents is recorded. The document is a collection of one or more words or sentences (which may, of course, include alphanumeric characters and foreign languages). The document data may be data in any format as long as a sentence is expressed. For example, the document data is data expressing a document in a text format, or data in a format specialized for a specific application. Alternatively, the document data may be data expressing a word or a sentence itself or data expressing a concept corresponding to a word or a sentence using, for example, an image, audio, or video (a moving image). In other words, the document data may be image data, audio data, or video data. Furthermore, the format of storing the document data is not limited to any particular format. For example, the document data may be stored in a file, stored as a record in a database, or stored in another format.

When document information relating to certain knowledge is collected, the operator can obtain a desired piece of knowledge by, for example, browsing the document data of the document information.

The information management apparatus 20 is configured with one or more computers that store pieces of information (document information) to be collected and store a workspace in which the collected pieces of document information (document data) are classified and managed. The workspace is a collection of pieces of document information, which is generated when the collected pieces of document information are classified based on the commonality of input information. The workspace serves as a management unit. The collection of the pieces of document information serves as data and may also be referred to as already registered data. Accordingly, multiple workspaces may be generated. One or more pieces of document information (document data) belong to one workspace. The commonality of the input information is, for example, that pieces of document information have a commonality because the pieces of document information are collected for the same query (that serves as input information). The query is a character string that is designated by the operator when document information is collected and expresses the document information to be collected in a natural language. In the present embodiment, the query is a part of a collection condition for collecting the document information. One workspace includes one or more groups. A group is a collection (group) of one or more pieces of document information formed by dividing a collection of the pieces of document information (that serves as the data and may also be referred to as the already registered data) belonging to a workspace (that serves as the management unit) based on the degree of similarity of a feature amount (a document vector to be described later) of each piece of document information. One group includes one or more pieces of document information.

The information collection apparatus 10 is configured with one or more computers that collect, based on a collection condition for collecting document information input by the operator, document information that satisfies the collection condition from the information management apparatus 20. The information collection apparatus 10 also executes a process for supporting the classification of the collected document information.

The information management apparatus 20 and the information collection apparatus may be implemented by using the same computer. In this case, the network N1 corresponds to a signal line such as a bus in the computer with which the information management apparatus 20 and the information collection apparatus 10 are configured. Alternatively, one of the communication terminals 30 may serve as the information collection apparatus 10. In this case, the network N3 corresponds to a signal line such as a bus in the one of the communication terminals 30.

The scene (situation) in which the information collection system is used is not limited to a predetermined format. For example, the information collection system may be used in a company. Accordingly, each employee of the company may be the operator. In addition, each temporary employee, each part-timer, or each moonlighter of public offices, various organizations, or unions can be the operator. In the present embodiment, an individual employee of the company is described as the operator. However, the operator is not limited to the individual employee of the company. The present embodiment is applicable to a case where this information collection system is used by a general user.

In this case, the information management apparatus 20 is a group of computers that manage various information in the company. For example, the information management apparatus 20 manages document information relating to various document data created in the company, information relating to an organizational structure of the company, information relating to the employees of the company, and workspaces generated based on information collected in the company. The information management apparatus 20 may also manage electronic communication (e.g., e-mail or chat) in business among the employees of the company. In this case, the network N2 corresponds to, for example, a wide area network (WAN) or a local area network (LAN) in the company.

The information collection apparatus 10 may be installed within the company or may be installed outside the company (for example, in a cloud environment, such as a data center, connected to a network within the company via the Internet). In the case where the information collection apparatus 10 is installed within the company, the network N1 and the network N3 correspond to, for example, the WAN or the LAN within the company. In the case where the information collection apparatus 10 is installed outside the company, the network N1 and the network N3 correspond to, for example, the Internet. The information collection apparatus 10 may collect information desired by the operator from information made public outside the company.

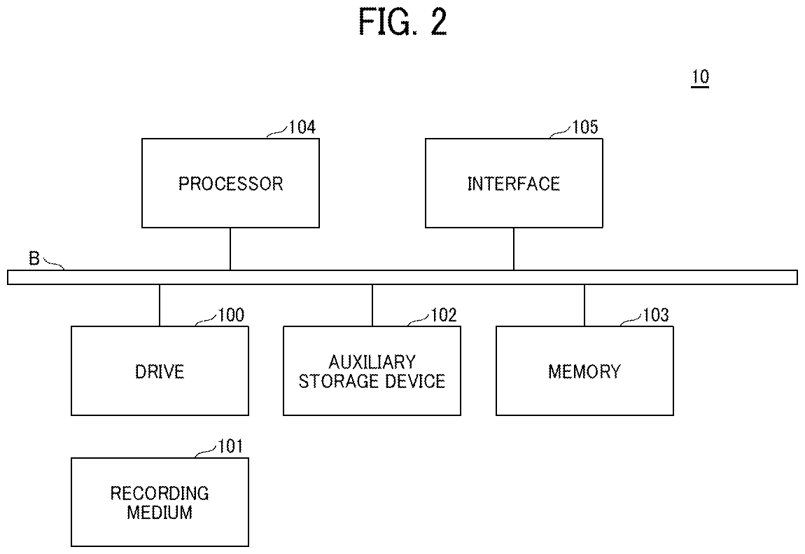

FIG. 2 is a block diagram illustrating a hardware configuration of the information collection apparatus 10 according to the first embodiment of the present disclosure. The information collection apparatus 10 in FIG. 2 includes, for example, a drive 100, an auxiliary storage device 102, a memory 103, a processor 104, and an interface 105, which are connected to each other via a bus B.

The program for implementing the processing executed by the information collection apparatus 10 is provided in a recording medium 101 such as a compact disc-read-only memory (CD-ROM). When the recording medium 101 storing the program is set in the drive 100, the program is installed in the auxiliary storage device 102 from the recording medium 101 through the drive 100. However, the program is not necessarily installed from the recording medium 101, but may be installed by being downloaded from another computer via a network. The auxiliary storage device 102 stores the installed program and also stores, for example, files and data to be used.

The memory 103, in response to an instruction to activate the program, reads the program from the auxiliary storage device 102 and stores the program. The processor 104 is a central processing unit (CPU), a graphics processing unit (GPU), or the CPU and the GPU, and executes functions of the information collection apparatus 10 in accordance with the program stored in the memory 103. The interface 105 is used as an interface for connecting to a network.

The information management apparatus 20 and the communication terminal 30 may also have the same hardware configuration as that of FIG. 2.

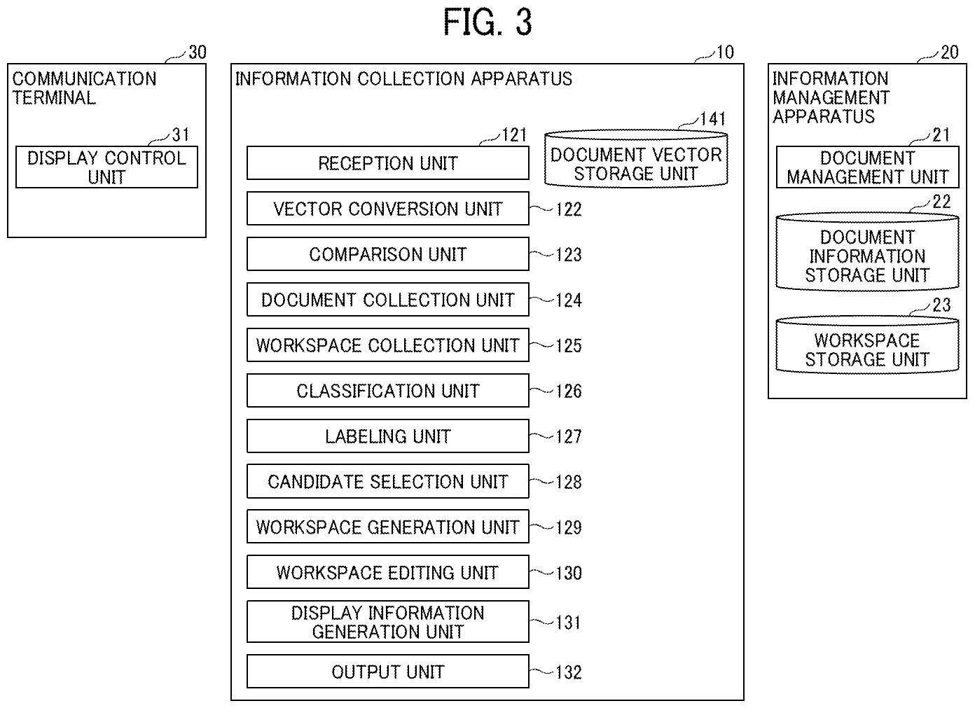

FIG. 3 is a block diagram illustrating a functional configuration of the information collection system according to the first embodiment of the present disclosure. As illustrated in FIG. 3, the communication terminal 30 includes a display control unit 31. The display control unit 31 is implemented by the processor of the communication terminal 30 executing instructions included in one or more programs (for example, programs of a web browser) installed in the communication terminal 30.

The display control unit 31 displays a screen based on display information transmitted from the information collection apparatus 10, and transmits a request corresponding to an input to the screen to the information collection apparatus 10.

The information management apparatus 20 includes a document management unit 21. The document management unit 21 is implemented by the processor of the information management apparatus 20 executing instructions included in one or more programs installed in the information management apparatus 20. The information management apparatus 20 uses, for example, a document information storage unit 22 and a workspace storage unit 23. Each of these storage units is implemented by using, for example, an auxiliary storage device of the information management apparatus 20 or a storage device connectable to the information management apparatus 20 via a network.

The document management unit 21 registers a plurality of pieces of document information in the document information storage unit 22, and updates or deletes a plurality of pieces of document information stored in the document information storage unit 22.

The workspace storage unit 23 stores information regarding workspaces. The information regarding a certain workspace is, for example, information regarding a collection of pieces of document information belonging to the workspace or information regarding groups into which the collection of the pieces of document information is divided.

The information collection apparatus 10 includes a reception unit 121, a vector conversion unit 122, a comparison unit 123, a document collection unit 124, a workspace collection unit 125, a classification unit 126, a labeling unit 127, a candidate selection unit 128, a workspace generation unit 129, a workspace editing unit 130, a display information generation unit 131, and an output unit 132. These functional units provide functions implemented by the processor 104 executing instructions included in one or more programs installed in the information collection apparatus 10. The information collection apparatus 10 uses a document vector storage unit 141. The document vector storage unit 141 is implemented by using, for example, the auxiliary storage device 102 or a storage device connectable to the information collection apparatus 10 via a network.

The reception unit 121 receives a collection request for collecting information desired by the operator from the communication terminal 30. The collection request for collecting information includes a condition (collection condition) relating to the collection of information. The collection condition includes a type of information (referred to as an “information type” in the following description) to be collected and a character string (referred to as a “query” in the following description) that expresses the information to be collected in a natural language.

In the present embodiment, the options of the information type are, for example, a “document” and a “workspace.” The “document” is an information type corresponding to document information. The “workspace” is an information type corresponding to a workspace.

The query is, for example, a collection of one or more words. The query may be a list of one or more words or may have a form of one or more sentences.

The vector conversion unit 122 analyzes the query included in the collection condition and the document data relating to each piece of document information stored in the document information storage unit 22, and converts the query or the document data into a feature amount. In the present embodiment, data in a vector format (simply referred to as a “vector” in the following description) is given by way of example as the feature amount. The vector is also called a distributed representation or an embedded representation, and is a feature amount corresponding to the meaning included in the data (such as the query or the document data) to be converted. For example, the vector conversion unit 122 generates a vector using natural language processing such as Bidirectional Encoder Representations from Transformers (BERT). The model of BERT may be switched by using the attributes of the operator. The vector conversion unit 122 generates a vector of each piece of document data in advance and stores the generated vector in the document vector storage unit 141. In the following description, a vector generated based on a query is referred to as a “query vector,” and a vector generated based on document data is referred to as a “document vector.”

The comparison unit 123 compares the query vector with each document vector and evaluates the similarity of each document vector to the query vector. In the present embodiment, the index for evaluating the similarity is referred to as the “degree of similarity.”

The document collection unit 124 extracts (collects) document information (document data) relating to the query based on the degree of similarity of each document vector to the query vector, which is the result of comparing the query vector with each document vector.

The process of “comparison” executed by the comparison unit 123 may be referred to as “search,” and the result of comparison executed by the comparison unit 123 may be referred to as a search result. In such a case, the collection of information may be referred to as information search or simply search.

When an existing workspace or a new workspace generated based on an existing workspace is designated as a registration destination for the document information collected by the document collection unit 124, the workspace collection unit 125 collects (retrieves) an existing workspace as a candidate for the registration destination or an existing workspace as a source for the new workspace from the workspace storage unit 23.

When a new workspace that is empty is designated as a registration destination for the document information collected by the document collection unit 124, the classification unit 126 classifies a plurality of pieces of document information (which is document data and serves as the second data) extracted by the document collection unit 124 into a plurality of groups based on a document vector (that serves as the feature amount) of each piece of document information. For example, clustering is used for classification. A class classified using clustering corresponds to one group that forms a workspace. The new workspace that is empty refers to a new workspace that is not based on an existing workspace.

The labeling unit 127 attaches a label to a workspace that is newly generated as a registration destination for the document information collected by the document collecting unit 124 or a group. The labeling unit 127 also attaches a label to each document data in advance based on the contents of each document data. The result of attaching the label to each document data is stored in the document information storage unit 22. In the present embodiment, the label is a character string (for example, a “word”) that (simply) indicates a feature of an object to which the label is attached.

The candidate selection unit 128 supports assignment of the document information collected by the document collection unit 124 to a workspace and a group. Specifically, the candidate selection unit 128 selects some workspaces as candidates of the registration destination for document information to be registered based on a document vector (that serves as the feature amount) of the document information (that serves as the first data) to be registered and document vectors (that serve as the feature amount) of pieces of document information (which are document data, serve as one or more pieces of data, and may also be referred to as the already registered data) belonging to a plurality of workspaces (serves as the management unit). The candidate selection unit 128 also selects a group as a candidate of an assignment destination for the document information (that serves as the first data) from the groups belonging to the selected some workspaces, based on a document vector (that serves as the feature amount) of the document information (that serves as the data) belonging to each of the groups (that serve as one or more groups into which the management unit is divided) belonging to the workspace selected as the registration destination from the some workspaces selected as the candidates of the registration destination for the document information to be registered and the feature amount of the document information (that serves as the first data) to be registered. Alternatively, the candidate selection unit 128 selects a group as a candidate of the assignment destination for the document information (that serves as the first data) to be registered in a new workspace divided into the same groups as those of the workspace selected as the registration destination, based on a document vector (that serves as the feature amount) of the document information (that serves as the data) belonging to each of the groups (that serve as the one or more groups into which the management unit is divided) belonging to the workspace selected as the registration destination from the some workspaces selected as the candidates of the registration destination for the document information to be registered and the feature amount of the document information (that serves as the first data) to be registered. Alternatively, the candidate selection unit 128 selects a group as a candidate of the assignment destination for the document information (that serves as the first data) to be registered in a new workspace to which the same pieces of document information (that serve as the data) of the workspace selected as the registration destination belong and which is divided into the same groups as those of the workspace selected as the registration destination, based on a document vector (that serves as the feature amount) of the document information (that serves as the data) belonging to each of the groups (that serve as the one or more groups into which the management unit is divided) belonging to the workspace selected as the registration destination from the some workspaces selected as the candidates of the registration destination for the document information to be registered and the feature amount of the document information (that serves as the first data) to be registered. In this way, the candidate selection unit 128 supports the assignment of the document information to the workspace and the group. In the present embodiment, assigning document information to a workspace is also referred to as registration of document information in a workspace or assignment of document information to a workspace. Further, assigning document information to a group is also referred to as registration of document information in a group or assignment of document information to a group.

In this disclosure, assignment destination is where the document information is to be classified, such as a workspace or a group.

When the pieces of document information collected by the document collection unit 124 are instructed to be registered in a new workspace, the workspace generation unit 129 (that serves as a generation device) newly generates a workspace (that serves as the management unit) to which the pieces of document information (that serve as the second data) belong, and divides the newly generated workspace (that serves as the management unit) into a plurality of groups classified by the classification unit 126. At this time, the workspace generation unit 129 registers a new record corresponding to the newly generated workspace in the workspace storage unit 23.

When the pieces of document information collected by the document collection unit 124 are instructed to be registered in an existing workspace, the workspace editing unit 130 reflects a change for registering the pieces of document information in the existing workspace in the workspace storage unit 23.

The display information generation unit 131 generates display information to be displayed by the communication terminal 30. For example, the display information generation unit 131 generates, for example, display information indicating a result of collecting the document information and display information for receiving an instruction regarding the assignment of the collected document information to the workspace and the group from the operator. For example, in the case where the display control unit 31 of the communication terminal 30 is implemented by a web browser, a web page serves as the display information. However, the display information may be generated in another format.

The output unit 132 outputs the display information (e.g., information indicating a candidate of the registration destination, information indicating a candidate of the assignment destination) generated by the display information generation unit 131, and transmits the display information to the communication terminal 30.

The functional configuration (the assignment of the functions) illustrated in FIG. 3 is merely given by way of example. The apparatus in which each functional unit is arranged may be changed to any one of the communication terminal 30, the information collection apparatus 10, and the information management apparatus 20 as appropriate.

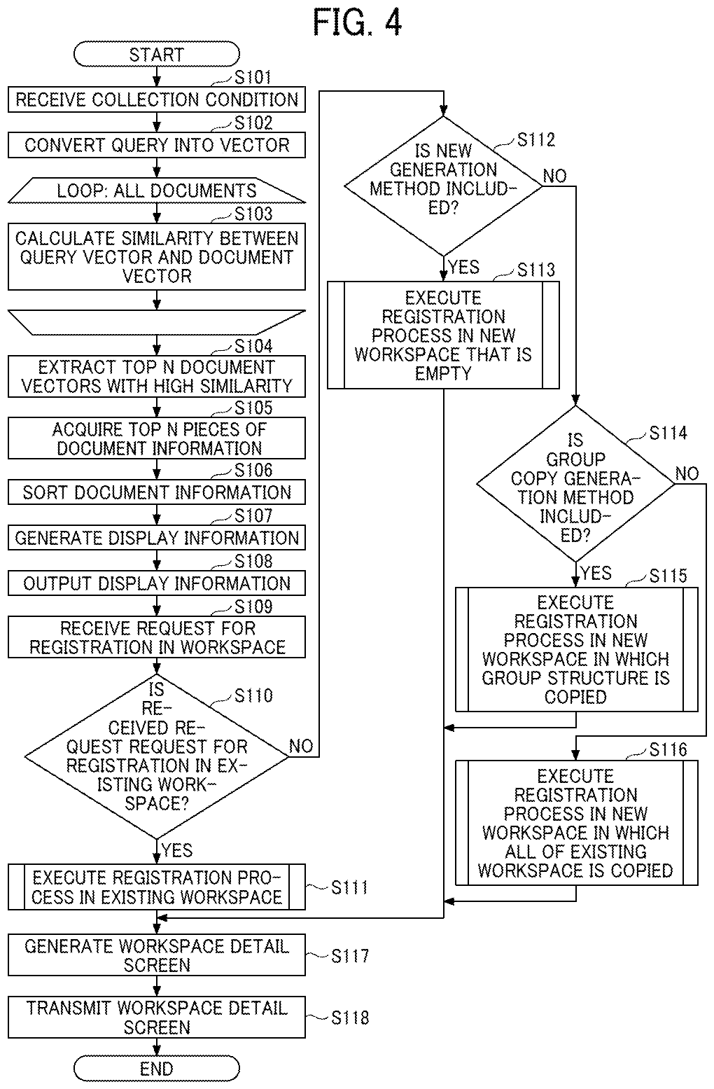

The processing executed by the information collection system is described below. FIG. 4 is a flowchart of the processing executed by the information collection system according to the first embodiment of the present disclosure.

In step S101, the display control unit 31 of the communication terminal 30 receives an input of a collection condition from the operator through a collection condition input screen displayed on the display of the communication terminal 30.

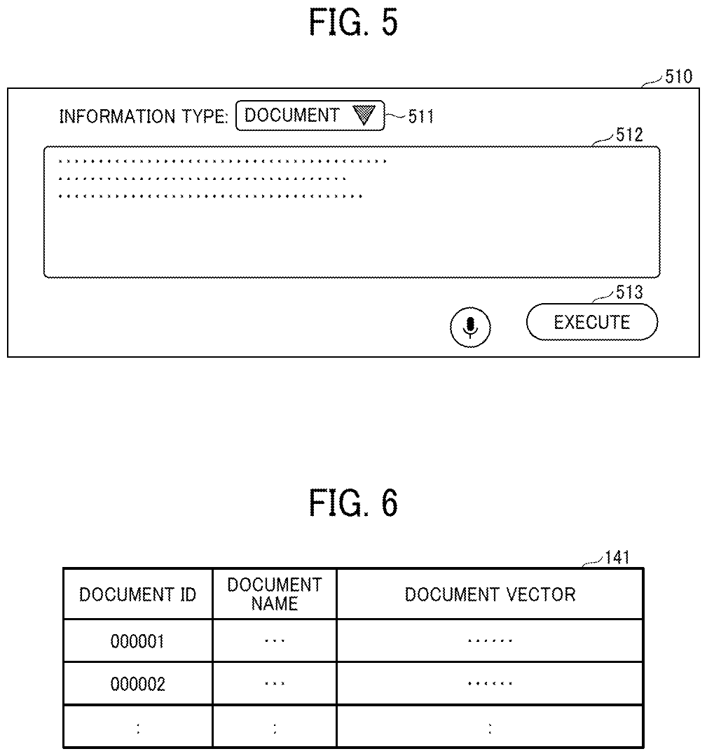

FIG. 5 is a diagram illustrating the collection condition input screen according to an embodiment of the present disclosure. As illustrated in FIG. 5, a collection condition input screen 510 includes, for example, an information type selection field 511, a query input field 512, and an execution button 513. The information type selection field 511 is a field for receiving selection of an information type. In the present embodiment, since the options of the information type are the “document” and the “workspace,” the information type selection field 511 may be a list box including options corresponding to the “document” and the “workspace.” In the present embodiment, a case where the “document” is selected is described with reference to FIG. 5.

The query input field 512 is a field for receiving an input of a query. The query may be input using, for example, a keyboard (including direct input through a touch panel) of the communication terminal 30, or may be input by voice through a microphone of the communication terminal 30.

The execution button 513 is a button for receiving an instruction to execute information collection (search execution).

The collection condition input screen 510 may be displayed on the communication terminal 30 in response to, for example, a login to the information collection apparatus 10 operated by the operator. In the following description, the operator who inputs a collection condition (search condition) is referred to as a “login operator.” The login operator is also the operator who requests assignment of the collected document information to a workspace and a group.

In response to an operation to press the execution button 513 operated by the login operator after an information type is selected and a query is input, the display control unit 31 transmits an information collection request that includes the selected information type and the input query as the information collection condition to the information collection apparatus 10.

When the reception unit 121 of the information collection apparatus 10 receives the information collection request, the vector conversion unit 122 converts the query (referred to as a “target query” in the following description) included in the information collection request (referred to as a “target collection request” in the following description) into a query vector (S102).

The comparison unit 123 compares the query vector with the document vector corresponding to the document data for each piece of document data relating to the document information managed by the information management apparatus 20, and calculates the degree of similarity between the query vector and the document vector (S103). The document vectors corresponding to the pieces of document data managed by the information management apparatus 20 are stored in the document vector storage unit 141.

FIG. 6 is a diagram illustrating the structure of the document vector storage unit 141 according to an embodiment of the present disclosure. As illustrated in FIG. 6, the document vector storage unit 141 stores a document identification (ID), a document name, and a document vector for each piece of document data. The document ID is identification information for identifying the document information relating to the document data, and associates the document information stored in the information management apparatus 20 and the document vector stored in the document vector storage unit 141 with each other. The document name is a name or title of the document data. For example, in the case where the document data is stored in a file format, a file name may be used as the document name. The document vector, like the query vector, is a vector representation (for example, a distributed representation or an embedded representation) corresponding to the meaning included in the contents of the document data.

The degree of similarity between the query vector and the document vector is calculated using an angle (the degree of cosine similarity) or a distance between the query vector and the document vector, similar to the calculation of the degree of similarity between general vectors. For example, in the case where the degree of cosine similarity is used, the degree of cosine similarity between a “vector a” and a “vector b” is calculated according to the following formula.

$$cos ( a , b ) = \frac{a \cdot b}{‖ a ‖ ‖ b ‖}$$

When the degree of similarity between the query vector and the document vector is calculated for all the document vectors, the comparison unit 123 extracts the top N document vectors with a high degree of similarity (S104). In other words, N document vectors are extracted in descending order of the degree of similarity to the query vector. Note that the value of N is an integer of one or more and is set in advance. Alternatively, a threshold value may be set for the degree of similarity, and the number of document vectors having the degree of similarity equal to or greater than the threshold value may be N.

The document collection unit 124 acquires (extracts) the document information of the document data relating to each of the extracted N document vectors from the document information storage unit 22 based on the document ID of each of the extracted N document vectors (S105).

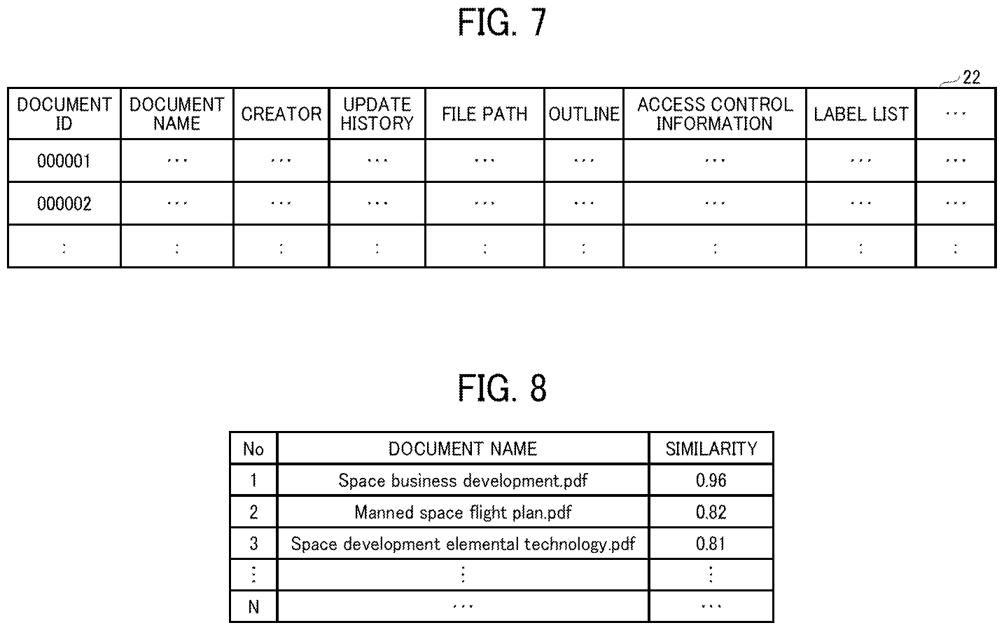

FIG. 7 is a diagram illustrating the structure of the document information storage unit 22 according to an embodiment of the present disclosure. As illustrated in FIG. 7, the document information storage unit 22 stores one or more records that include, for example, a document ID, a document name, a creator, an update history, a file path, an outline, access control information, and a label list. One record corresponds to one piece of document information.

The document ID and the document name are as described above. The document ID and the document name for the same document data are the same in the document information storage unit 22 and the document vector storage unit 141.

The creator is identification information for identifying the creator of the document data. The update history is information that includes the date of update and identification information of the updater for each update of the document data. In the present embodiment, it is assumed that the identification information of the creator or the updater of the document data is an employee ID of a company (referred to as a “company X” in the following description) in which the information management apparatus 20 is used. The file path is a path name of a file in which the document data that is the substance of the document information is stored. The outline is an outline (for example, a summary sentence) of the contents included in the document data. The access control information is information for restricting operators allowed to access the document information to a predetermined range of operators. In other words, the access control information is information indicating whether an individual operator has access authority. For example, the access control information may include information indicating an operator or a group of operators having viewing authority and information indicating an operator or a group of operators having writing authority. The group of operators refers to a collection of one or more operators. The label list is a list of each label (referred to as a “document label” in the following description) attached to the document data by the labeling unit 127. A word determined to be relatively important among the words included in the document data using, for example, term frequency-inverse document frequency (TF-IDF) may be used as the document label.

In step S105, pieces of document information to which the login operator has access authority are acquired from the N pieces of document information.

The document collection unit 124 sorts (arranges) the acquired pieces of document information in descending order of the degree of similarity (S106).

FIG. 8 is a diagram illustrating a sorting result of the pieces of document information according to an embodiment of the present disclosure. In FIG. 8, a table in which document names and the degrees of similarity are sorted is illustrated.

The display information generation unit 131 generates display information for displaying the sorting result as a collection result (search result) of the document information (S107). The display information generation unit 131 generates the display information based on, for example, the creator, the update history, the file path, the outline, and the label list of the pieces of document information for which the login operator has viewing authority among the N pieces of document data.

The output unit 132 transmits (outputs) the display information to the communication terminal 30 (S108). The display control unit 31 of the communication terminal 30 displays a search result screen as a result of collecting the pieces of document information based on the display information.

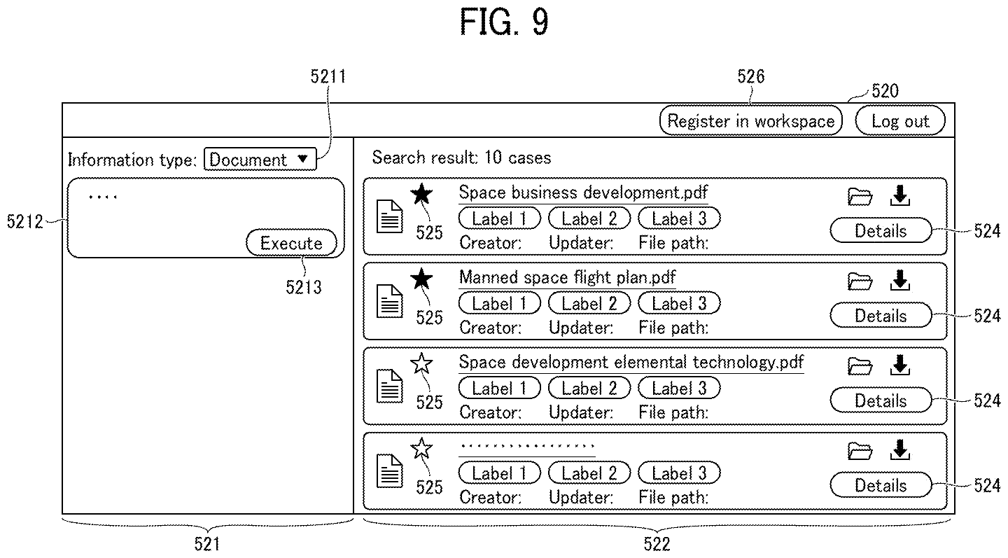

FIG. 9 is a diagram illustrating display of the search result screen according to an embodiment of the present disclosure. As illustrated in FIG. 9, a search result screen 520 includes an information collection condition display area 521 and a search result display area 522.

The information collection condition display area 521 is an area in which a collection condition for collecting a target is displayed, and includes an information type display field 5211 and a query display field 5212. The information type display field 5211 is a field in which the information type of the target is displayed. The query display field 5212 is a field in which a target query is displayed. The information type display field 5211 and the query display field 5212 may be operable. In this case, when the information type and the query are partially or entirely changed through the information type display field 5211 and the query display field 5212 and an execution button 5213 is pressed, the processes of step S101 and subsequent steps of FIG. 4 may be executed again.

The search result display area 522 is an area in which, for example, a creator, an updater, a file path, an outline, and a label list are displayed for each of the N pieces of document information. The updater may be, for example, an updater relating to the last update in the update history.

By referring to the search result screen 520, the login operator can check a list of pieces of document information collected in accordance with the collection condition for the target.

The login operator can register some or all of the pieces of document information included in the collection result in a new or existing workspace. Registering the collected results in the workspace can be compared to registering the collected results in a bookmark. In this case, the login operator selects a selection component 525 corresponding to a piece of document information to be registered in the workspace from selection components 525 arranged for respective pieces of document information in the search result screen 520 (FIG. 9). For example, the login operator selects one or more pieces of document information as the targets to be registered in the workspace. All of the pieces of document information included in the collection result may be allowed to select. When a registration button 526 for registration in a workspace is pressed in a state where one or more selection components 525 are selected, the display control unit 31 of the communication terminal 30 displays a screen (referred to as a “registration destination inquiry screen” in the following description) for inquiring the operator whether to register the pieces of document information selected as the targets to be registered in a new workspace or an existing workspace.

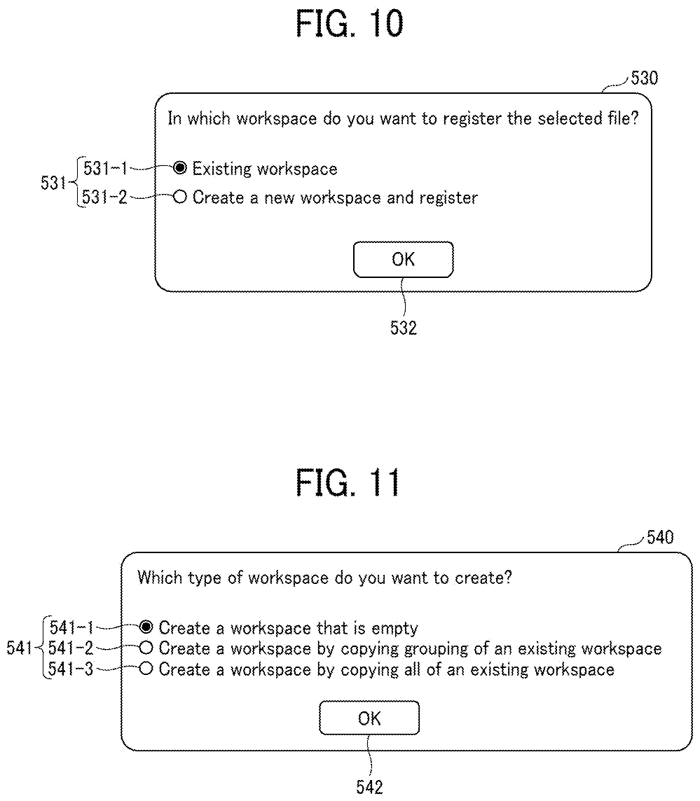

FIG. 10 is a diagram illustrating display of the registration destination inquiry screen according to an embodiment of the present disclosure. As illustrated in FIG. 10, a registration destination inquiry screen 530 includes radio buttons 531 and an OK button 532. The radio buttons 531 are operation components that include an option 531-1 and an option 531-2 and allow selection of only one of the options 531-1 and 531-2. The option 531-1 is an option corresponding to an instruction to set the registration destination for the document information to an existing workspace. The option 531-2 is an option corresponding to an instruction to set the registration destination for the document information to a new workspace.

When the OK button 532 is pressed in a state where the option 531-1 is selected on the registration destination inquiry screen 530, the display control unit 31 transmits a registration request for registration in an existing workspace to the information collection apparatus 10.

On the other hand, when the OK button 532 is pressed in a state where the option 531-2 is selected on the registration destination inquiry screen 530, the display control unit 31 displays a screen (referred to as a “workspace generation method inquiry screen” in the following description) for inquiring the operator of a method for generating the new workspace.

FIG. 11 is a diagram illustrating display of the workspace generation method inquiry screen according to an embodiment of the present disclosure. As illustrated in FIG. 11, a workspace generation method inquiry screen 540 includes radio buttons 541 and an OK button 542. The radio buttons 541 are operation components that include an option 541-1, an option 541-2, and an option 541-3 and allow selection of only one of the options 541-1 to 541-3. Each option corresponds to a method of generating a new workspace. In the present embodiment, three methods are described below as a method of generating a new workspace in which document information is to be registered.

The first method is a method of generating a workspace that is empty. The workspace that is empty is a workspace to which no group or document information belongs. In the following description, the first method is referred to as a “new generation method.”

The second method is a method of generating a new workspace by copying only the grouping (group classification) of an existing workspace to the new workspace. In this case, the pieces of document information belonging to the groups of the existing workspace that is the copy source are not copied to the groups of the new workspace that is the registration destination (copy destination). In the following description, the second method is referred to as a “group copy generation method.”

The third method is a method of generating a new workspace by copying not only the grouping of an existing workspace but also the pieces of document information belonging to the groups of the existing workspace to the new workspace. In the following description, the third method is referred to as a “all copy generation method.”

When the OK button 542 is pressed in a state where one of the options of the radio buttons 541 is selected on the workspace generation method inquiry screen 540, the display control unit 31 transmits, to the information collection apparatus 10, a registration request for registration in a workspace including the generation method corresponding to the option in the state of the selection and the document IDs of the one or more pieces of document information selected as the targets to be registered.

In step S109 of FIG. 4, the reception unit 121 receives the registration request for registration in an existing workspace or a request for registration in a new workspace transmitted by the display control unit 31. In the case where the received registration request is a registration request for registration in an existing workspace (YES in S110), the information collection apparatus 10 executes a process for registration in an existing workspace (S111).

On the other hand, in the case where the received registration request is a registration request for registration in a new workspace (NO in S110), the processing branches according to the method of generating a new workspace included in the registration request. In the case where the registration request includes the “new generation method” (YES in S112), the information collection apparatus 10 executes a process for registration in a new workspace that is empty (S113). In the case where the registration request includes the “group copy generation method” (NO in S112 and YES in S114), the information collection apparatus 10 executes a process for registration in a new workspace to which the group structure of an existing workspace is copied (S115). In the case where the registration request includes the “all copy generation method” (NO in S114), the information collection apparatus 10 executes a process for registration in a new workspace to which all of an existing workspace is copied (S116).

The contents stored in the workspace storage unit 23 are updated when the process of step S111, S113, S115, or S116 is executed.

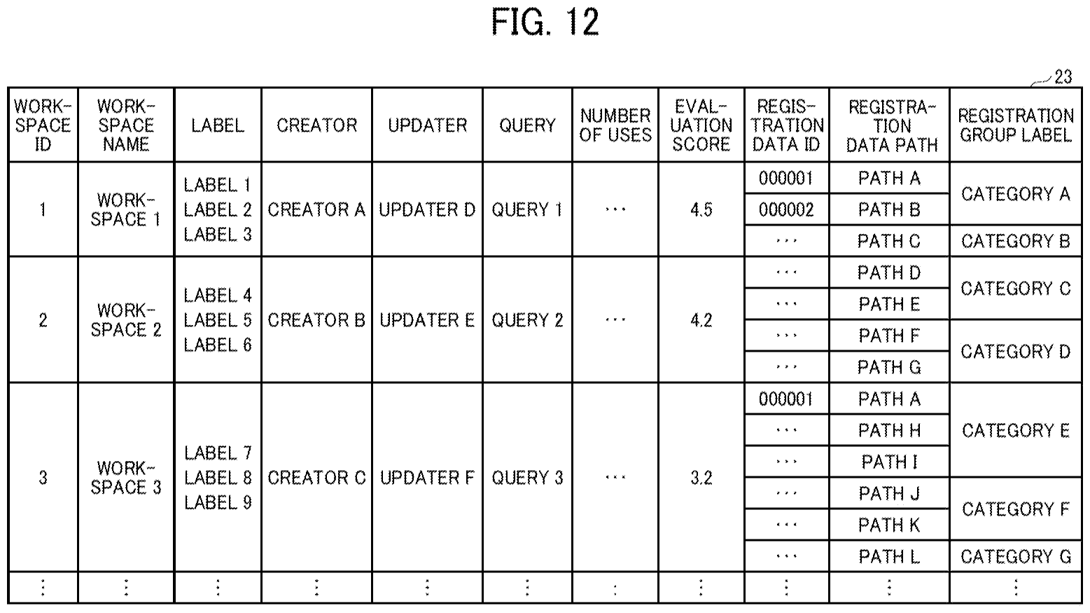

FIG. 12 is a diagram illustrating the structure of the workspace storage unit 23 according to an embodiment of the present disclosure. As illustrated in FIG. 12, the workspace storage unit 23 stores, for each workspace, a workspace including a workspace ID, a workspace name, a label, a creator, an updater, a query, the number of uses, an evaluation score, a registration data ID, a registration data path, and a registration group label.

The workspace ID is identification information for identifying the workspace. The workspace name is the name of the workspace input by the operator when the workspace is generated. As the creator, identification information (for example, an employee ID) for identifying an operator who has instructed the generation of the workspace is presented. As the updater, identification information (for example, an employee ID) for identifying a person who updates the workspace in the case where the workspace is updated is presented. In other words, the workspace can be updated. The query is a query input when the document information that is a base of the workspace is collected. Accordingly, it can be said that the query is information indicating the workspace is a collection of the document information collected based on what kind of viewpoint. The number of uses is the number of times the workspace is used (referred). The evaluation score is a value of evaluation input by the operator who has referred to the workspace. For example, the average value of the numerical value in a five point scale input by each operator is the evaluation score. The registration data ID (identification information) is a document ID of each piece of document information belonging to the workspace. The registration data path is a file path of document data relating to each piece of document information belonging to the workspace. The registration group label is a label (referred to as a “group label” in the following description) attached to a group to which each piece of document information in the column of the registration data ID belongs. The same registration group label is attached to the pieces of document information classified into the same registration group in the workspace.

In the following description, a record for each workspace ID in the workspace storage unit 23 is referred to as a “workspace record.” A record for each registration group label in one workspace record is referred to as a “group record.” A record for each registration data ID in one workspace record is referred to as a “document record.”

For example, in the case where the process of step S111 is executed, the registration data ID and the registration data path of the document information to be registered are added to the record of an existing workspace. On the other hand, in the case where the process of step S113, S115, or S116 is executed, a new workspace record is added in the workspace storage unit 23, and the registration data ID and the registration data path of the document information to be registered are registered in the new workspace record.

Subsequent to the process of step S111, S113, S115, or S116, the display information generation unit 131 generates, based on the updated workspace record of the workspace (referred to as a “target workspace” in the following description) in which the document information is to be registered, display information of a screen (referred to as a “workspace detail screen” in the following description) that indicates the detailed information of the target workspace (S117). In other words, the workspace detail screen generated at this point is a screen presenting the detailed information of the workspace reflecting the state in which the document information to be registered is registered.

The output unit 132 transmits the display information to the communication terminal (S118). The display control unit 31 of the communication terminal 30 displays the workspace detail screen based on the display information.

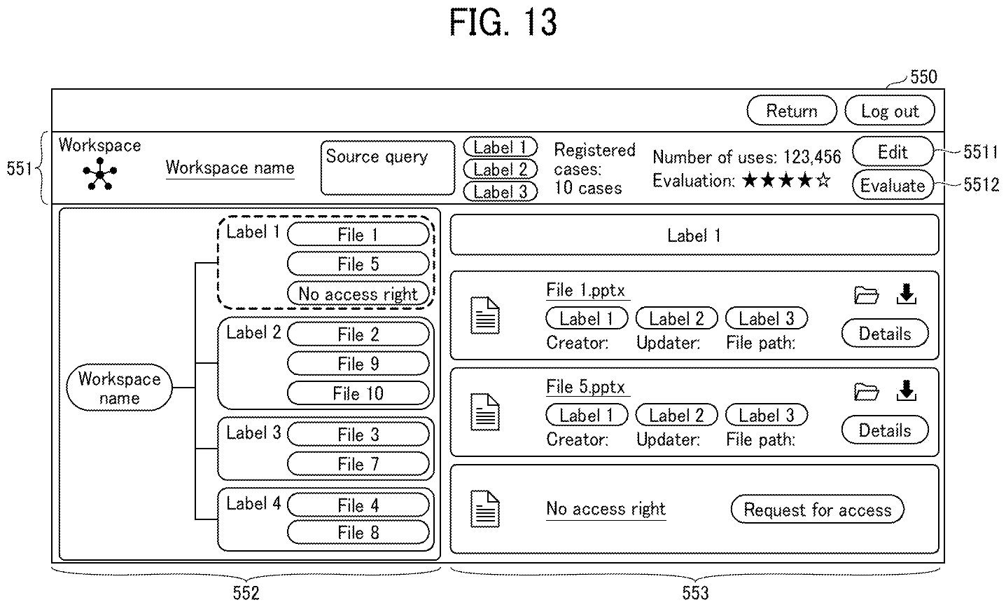

FIG. 13 is a diagram illustrating display of the workspace detail screen according to an embodiment of the present disclosure. As illustrated in FIG. 13, a workspace detail screen 550 includes a basic information display area 551, a structure display area 552, and a registration document display area 553.

The basic information display area 551 is an area in which information on the target workspace stored in the workspace storage unit 23 is presented, and includes an edit button 5511 and an evaluation button 5512.

The structure display area 552 is an area in which a relationship between a document information group that can be specified as belonging to the target workspace based on the registration group label and the registration data ID of the target workspace (see FIG. 12) and groups into which the document information group is divided is presented. In FIG. 13, a case in which three groups belong to the target workspace is illustrated.

The registration document display area 553 is an area in which a list of the pieces of document information belonging to a group (referred to as a “target group” in the following description) selected in the structure display area 552 is presented. In FIG. 13, “no access right” is displayed for the third piece of document information. The “no access right” indicates a piece of document information to which the login operator has no access authority.

The login operator can edit the workspace through the workspace detail screen 550. For example, the login operator can delete any one of the pieces of document information belonging to the target workspace from the target workspace or add a piece of document information to the target workspace. When the login operator presses the edit button 5511 after the execution of such an editing operation, the communication terminal 30 transmits the contents of the editing operation to the information collection apparatus 10. In response to receiving the contents of the editing operation, the workspace editing unit 130 of the information collection apparatus 10 reflects the contents of the editing operation in the workspace record corresponding to the target workspace in the workspace storage unit 23 (see FIG. 12).

In the case where the evaluation button 5512 is pressed on the workspace detail screen 550, the display control unit 31 of the communication terminal 30 displays a screen for receiving an input of an evaluation score. When one of integer values from one to five is input to the screen as an evaluation score, the display control unit 31 of the communication terminal 30 transmits the input evaluation score to the information collection apparatus 10. In response to receiving the evaluation score, the workspace generation unit 129 of the information collection apparatus 10 updates the number of uses and the evaluation score of the workspace record corresponding to the target workspace in the workspace storage unit 23 (see FIG. 12). Specifically, the workspace generation unit 129 adds one to the number of uses. Assuming that the number of uses before the update is x1, the number of uses after the update is x2, and the evaluation score before the update is y1, the workspace generation unit 129 calculates the evaluation score after an update of y2 as follows.

y2=y1×x1/x2

In the case where a link to one of the document names is selected in the registration document display area 553 on the workspace detail screen 550, the communication terminal 30, the information collection apparatus 10, and the information management apparatus 20 execute a process to output the document data. As a result of the process to output the document data, the operator can check the contents of the document data relating to the document name.

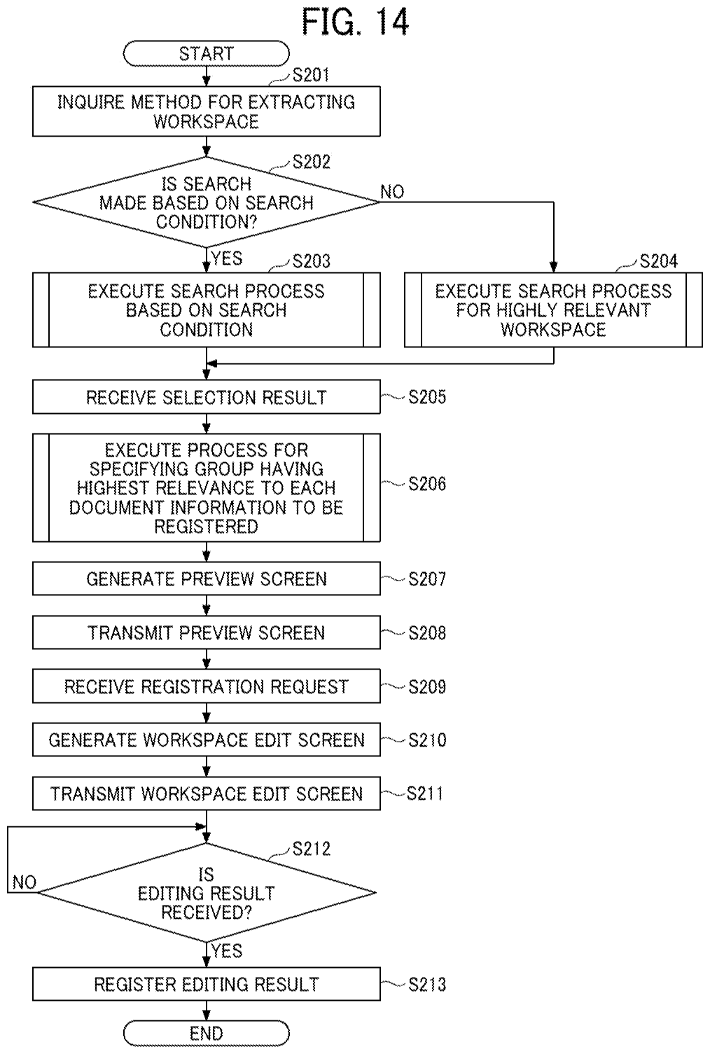

The process of step S111 in FIG. 4 is described below in detail. FIG. 14 is a flowchart of the processing for registration in an existing workspace according to an embodiment of the present disclosure.

In step S201, the information collection apparatus 10 executes a process to inquire the operator of a method for extracting (narrowing down to) a workspace as a candidate of the registration destination for the document information to be registered. Specifically, the output unit 132 transmits display information of a screen (referred to as a “workspace extraction method inquiry screen” in the following description) for inquiring the operator of a method for extracting the workspace to the communication terminal 30. The display control unit 31 of the communication terminal 30 displays the workspace extraction method inquiry screen based on the display information.

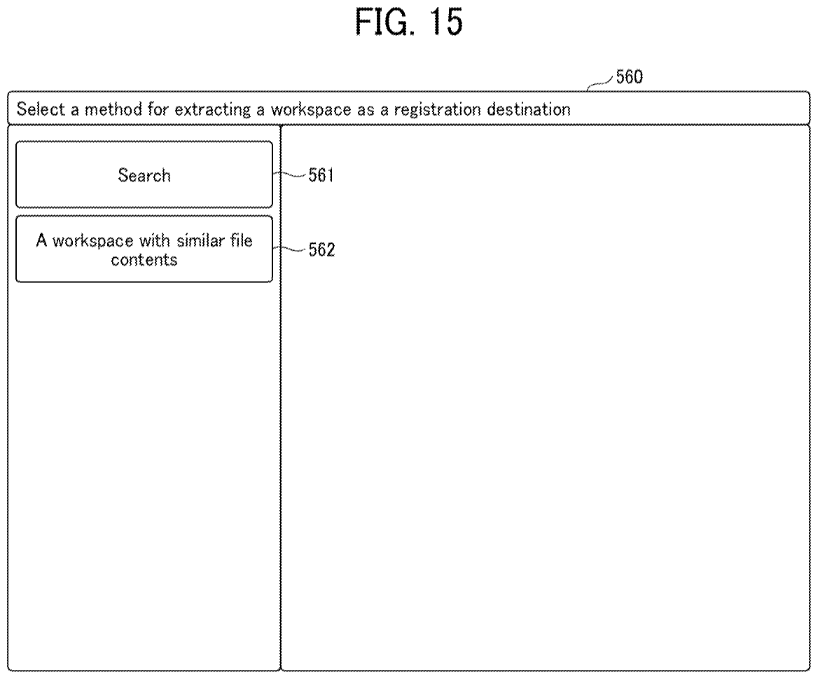

FIG. 15 is a diagram illustrating display of the workspace extraction method inquiry screen according to an embodiment of the present disclosure. As illustrated in FIG. 15, a workspace extraction method inquiry screen 560 includes a button 561 and a button 562. The button 561 is a button for receiving an instruction to use a search based on a search condition as a method for extracting a workspace. The button 562 is a button for receiving an instruction to use a search to search for a workspace that is highly relevant to the document information to be registered as a method for extracting a workspace. The workspace that is highly relevant to the document information to be registered is, for example, a workspace to which the pieces of document data having a relatively high degree of similarity to the document data relating to the document information to be registered belong among all workspaces (including some workspaces that are removed as noise).

When the button 561 or the button 562 is selected on the workspace extraction method inquiry screen 560, the display control unit 31 transmits a response indicating the method for extracting a workspace indicated by the button 561 or the button 562 to the information collection apparatus 10. The reception unit 121 receives the response.

In the case where the method for extracting a workspace is a search based on a search condition (YES in S202), the information collection apparatus 10 executes a process to search for a workspace based on a search condition (S203).

Specifically, the output unit 132 transmits display information of a workspace search screen to the communication terminal 30. The communication terminal 30 displays the workspace search screen based on the display information.

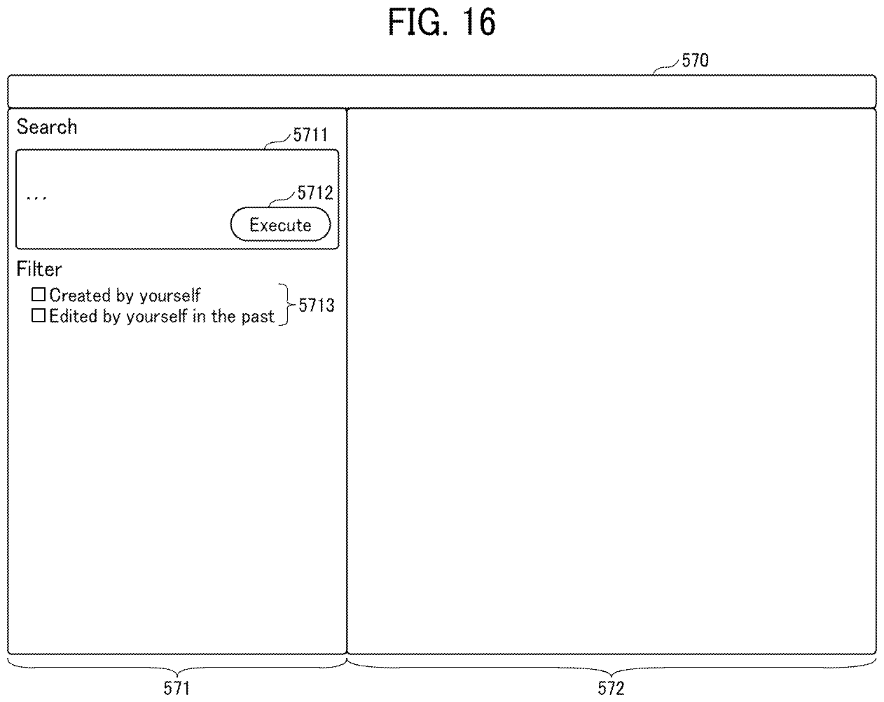

FIG. 16 is a diagram illustrating display of the workspace search screen according to an embodiment of the present disclosure. As illustrated in FIG. 16, a workspace search screen 570 includes a search condition input area 571 and a list display area 572. The search condition input area 571 is an area for receiving an input of a search condition, and includes, for example, a query input field 5711, an execution button 5712, and a filter selection field 5723.

The query input field 5711 is a field for receiving an input of a query. The query is a character string that expresses the workspace to be searched for in a natural language. The filter selection field 5723 is a field for receiving selection of a filter for narrowing down the workspaces to be searched for. On the workspace search screen 570 illustrated in FIG. 16, two filters are illustrated. One filter is “Created by yourself” (referred to as a “creator filter” in the following description) and the other filter is “Edited by yourself in the past” (referred to as an “edit filter” in the following description). The creator filter means that the creator of the workspace is the login operator. The edit filter means that the updater of the workspace is the login operator.

When the execution button 5712 is pressed, the display control unit 31 transmits, to the information collection apparatus 10, a search request for searching for a workspace, which includes a query (referred to as a “target query” in the following description) input in the query input field 5711 and the selected filter. When the reception unit 121 of the information collection apparatus 10 receives the search request, the workspace collection unit 125 searches the workspace storage unit 23 (see FIG. 12) for a workspace based on the search request.

Specifically, the workspace collection unit 125 executes the same processes as those of steps S102 to S104 in FIG. 4 based on the target query to extract N document vectors. The workspace collection unit 125 searches the workspace storage unit 23 for workspaces that include a document ID of any one of the N document vectors as a registration data ID. At this time, in the case where the search request includes a filter, the workspace collection unit 125 narrows down the workspaces to be included in the search result based on the filter.

In the case of such a search method (referred to as the “first search method” in the following description), if the document information relating to the N document vectors does not belong to any workspace, no workspace is searched. For this reason, the workspace collection unit 125 may calculate the degree of relevance between the workspace and the target query for each workspace registered in the workspace storage unit 23 (see FIG. 12). Then, the workspace collection unit 125 includes the top M workspaces having a high degree of relevance in the search result (such a search method is referred to as the “second search method” in the following description). The degree of relevance between a workspace and a target query is an index indicating the strength of the relevance between the workspace and the target query. The degree of relevance of a certain workspace to the target query may be calculated based on the degree of similarity between the document vector relating to each registration data ID belonging to the workspace and the query vector of the target query. For example, the degree of relevance may be a total value or the highest value of the degree of similarity between the document vector relating to each registration data ID belonging to the workspace and the query vector of the target query. Alternatively, the degree of relevance may be a total value of the highest value of the degree of similarity for each group belonging to the workspace. The workspace collection unit 125 may execute the second search method when no workspace is searched by the first search method, may execute only the second search method, or may integrate the search result obtained by the first search method and the search result obtained by the second search method.

The output unit 132 transmits the search result to the communication terminal 30. The display control unit 31 of the communication terminal 30 displays the search result in the list display area 572 on the workspace search screen 570.

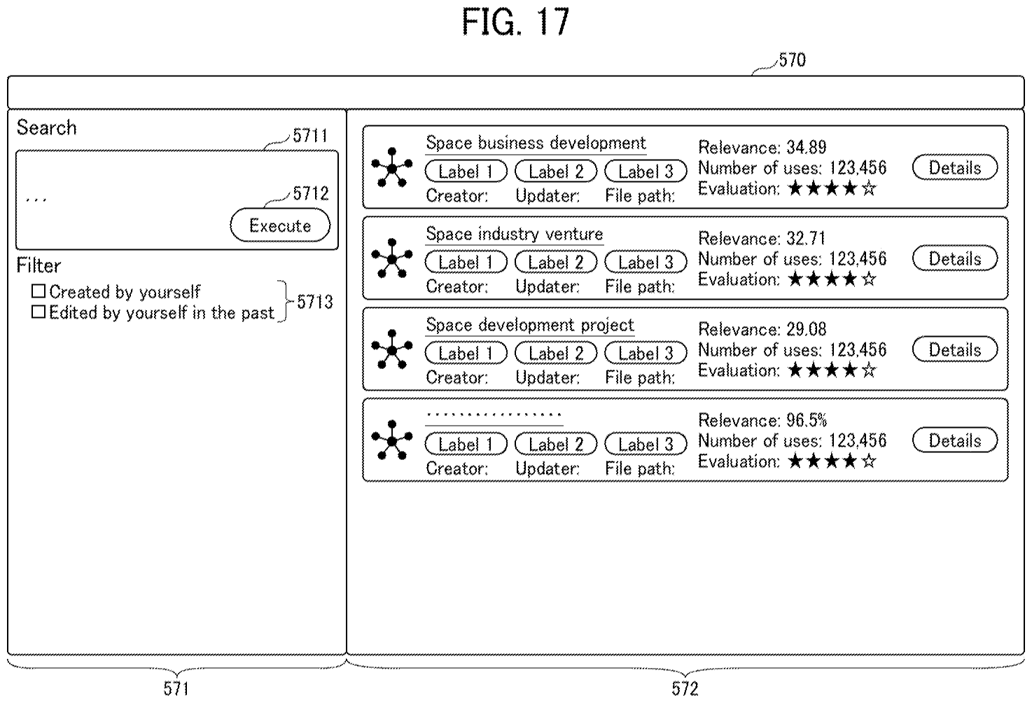

FIG. 17 is a diagram illustrating display of the search result of searching for a workspace according to an embodiment of the present disclosure. As illustrated in FIG. 17, a list of workspaces (four workspaces in the case illustrated in FIG. 17) included in the search result is added in the list display area 572.

On the other hand, in the case where the method for extracting a workspace selected by the operator is a search to search for a workspace that is highly relevant to the document information to be registered (NO in S202), the candidate selection unit 128 executes a process to search for a workspace that is highly relevant to the document information to be registered (referred to as a “relevant workspace” in the following description) (S204).

The process of step S204 in FIG. 14 is described below in detail. In the present embodiment, an index indicating a level of relevance between document information and a workspace is referred to as the “degree of relevance.”

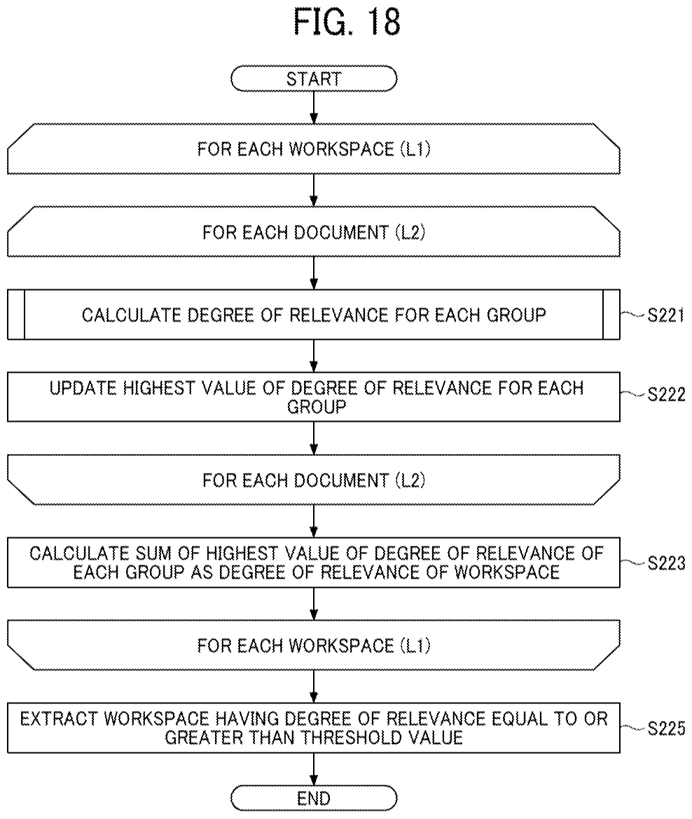

FIG. 18 is a flowchart of the processing to search for a relevant workspace according to the first embodiment of the present disclosure.

The candidate selection unit 128 selects, through the processing described below, some workspaces as candidates of the registration destination for the document information to be registered based on the document vector (that serves as the feature amount) of the document information to be registered (that serves as the first data) and the document vector of the document data belonging to a plurality of workspaces (serves as the management unit) to each of which one or more pieces of document data belong. Specifically, the candidate selection unit 128 executes loop processing L1 for each workspace included in a population. The population in the present embodiment is all workspaces registered in the workspace storage unit 23. In the following description, the workspace subjected to the loop processing L1 is also referred to as a “target workspace.”

In one loop of the loop processing L1, the candidate selection unit 128 executes loop processing L2 in which the processes of steps S221 and S222 are included and the process of step S223 for each piece of document information to be registered. The document information subjected to the loop processing L2 is referred to as “target document information.”

In step S221, the candidate selection unit 128 executes a process to calculate the degree of relevance between the target document information and each group belonging to the target workspace. The candidate selection unit 128 updates the highest value of the degree of relevance of each group based on the calculated degree of relevance between the target document information and each group (S222). Specifically, the candidate selection unit 128 compares the degree of relevance calculated in step S221 with the current highest value of the degree of relevance of each group. For a group whose current highest value of the degree of relevance is smaller than the degree of relevance with the target document information calculated in step S221, the candidate selection unit 128 sets the degree of relevance calculated for the group in step S221 as the highest value of the degree of relevance for the group. The initial value of the highest value of the degree of relevance of each group is zero.

When the loop processing L2 is executed for all the pieces of document information to be registered, the candidate selection unit 128 calculates a sum of the highest value of the degree of relevance of each group belonging to the target workspaces as the degree of relevance between the target workspace and the document information to be registered (S223).

When the loop processing L1 is executed for all the workspaces, the candidate selection unit 128 extracts workspaces whose degree of relevance is equal to or greater than a threshold value (S225).

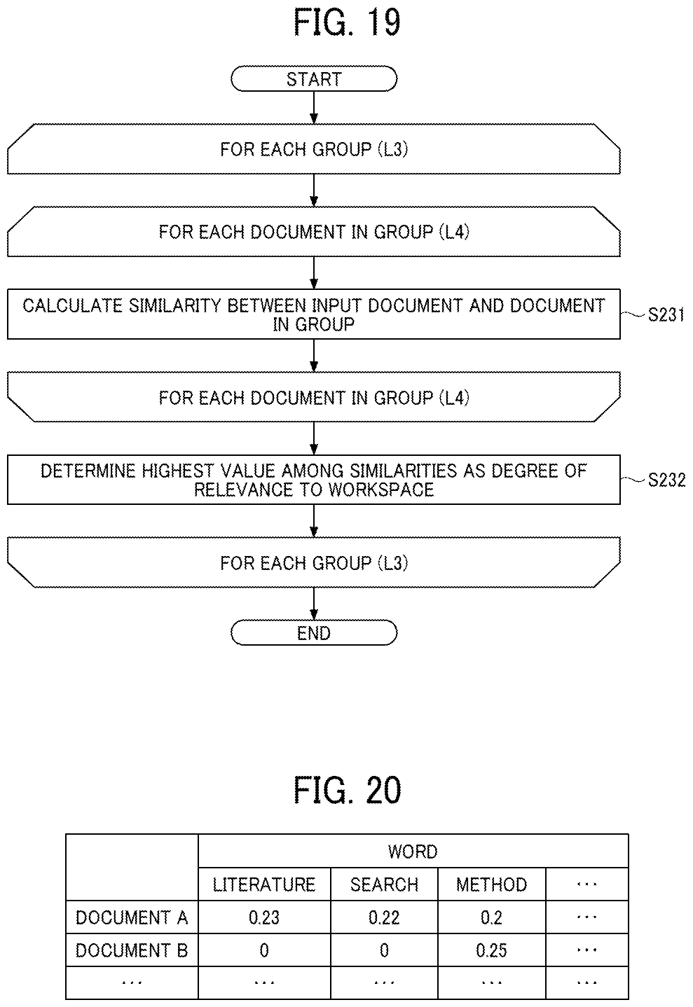

The process of step S221 in FIG. 18 is described below in detail. FIG. 19 is a flowchart of the processing to calculate the degree of relevance for each group according to an embodiment of the present disclosure. The target document information at the time when the processing in FIG. 19 is called in FIG. 18 is referred to as “input document information” in FIG. 19.

The candidate selection unit 128 executes loop processing L3 for each group belonging to the target workspace. The group subjected to the loop processing L3 is referred to as a “target group.”

In one loop of the loop processing L3, the candidate selection unit 128 executes loop processing LA in which the process of step S231 is included for each piece of document information belonging to the target group. The document information subjected to the loop processing L4 is referred to as “target document information.”

In step S231, the candidate selection unit 128 calculates the degree of similarity between the document data relating to the input document information and the document data relating to the target document information.

When the loop processing L3 is executed for all the pieces of document information belonging to the target group, the candidate selection unit 128 sets the highest value among the degrees of similarity calculated for each piece of document information belonging to the target group as the degree of relevance between the input document information and the target group (S232). Alternatively, instead of the highest value, an average value of the degrees of similarity calculated for each piece of document information belonging to the target group may be adopted as the degree of relevance between the input document information and the target group.

The following two types are given by way of example as the degree of similarity between two pieces of document data in step S231.

One type is the degree of cosine similarity of document vectors stored in the document vector storage unit 141 (see FIG. 6) for the two piece of document data. Such a degree of similarity can be said to be the degree of similarity based on the similarity in meaning. In the following description, the degree of relevance based on the degree of similarity between document vectors is referred to as the “degree of semantic relevance.”

The other type is the statistical amount using TF-IDF (see FIG. 20) of two piece of document data. The statistical amount also serves as the feature amount of document data. The degree of cosine similarity between the vectors of TF-IDF values of the two pieces of document data is given by way of example. The vector of TF-IDF value is, for example, data corresponding to one row in the table illustrated in FIG. 20. Such a degree of similarity can be said to be the degree of similarity based on the similarity of appearing words. In the following description, the degree of relevance based on the degree of similarity of vectors of TF-IDF values is referred to as the “degree of wording relevance.”

In the present embodiment, it is assumed that both the degree of semantic relevance and the degree of wording relevance between the pieces of document information to be registered are calculated for each workspace and each group belonging to the workspace. In step S225 in FIG. 18, workspaces whose degree of semantic relevance or degree of wording relevance is equal to or greater than a threshold value are extracted as relevant workspaces. In this case, the threshold value for the degree of semantic relevance and the threshold value for the degree of wording relevance may be the same value or may be different values. When the degree of semantic relevance and the degree of wording relevance are not distinguished from each other, they are simply referred to as the “degree of relevance.”

When relevant workspace whose degree of relevance is equal to or greater than the threshold value are extracted in step S225 of FIG. 18, the display information generation unit 131 generates display information of a screen (referred to as a “relevant workspace list screen” in the following description) that includes the extraction result. The output unit 132 transmits the display information to the communication terminal 30. The display control unit 31 of the communication terminal 30 displays the relevant workspace list screen based on the display information.

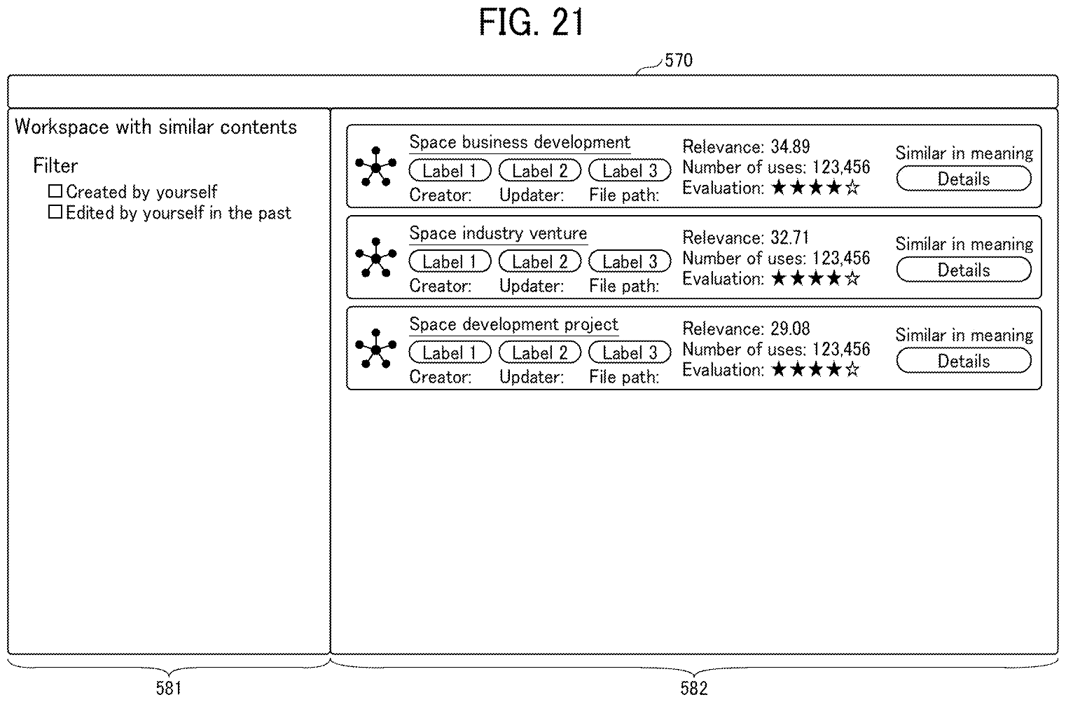

FIG. 21 is a diagram illustrating display of the relevant workspace list screen according to an embodiment of the present disclosure. As illustrated in FIG. 21, a relevant workspace list screen 580 includes a filter selection area 581 and a list display area 582.

The list display area 582 is an area in which a list of workspaces included in the extraction result is displayed. A label of “similar in meaning” is attached to each of workspaces extracted based on the degree of semantic relevance. A label of “similar in wording” is attached to each of workspaces extracted based on the degree of wording relevance.

The filter selection area 581 is an area for receiving selection of a filter for narrowing down the workspaces displayed in the list display area 582. On the relevant workspace list screen 580 illustrated in FIG. 21, the contents of the filters are the same as those on the workspace search screen 570 illustrated in FIG. 16. When one of the filters is selected, the display control unit 31 excludes workspaces that do not satisfy the content of the selected filter from the list display area 582.

Each of the workspaces displayed on the workspace search screen 570 (in FIG. 17) displayed on the communication terminal 30 in step S203 of FIG. 14 or on the relevant workspace list screen 580 (in FIG. 21) displayed on the communication terminal 30 in step S204 of FIG. 14 are referred to as a “candidate workspace.” The candidate workspace is a workspace as a candidate of the registration destination for the document information to be registered.

When one of the candidate workspaces displayed on the workspace search screen 570 (in FIG. 17) or on the relevant workspace list screen 580 (in FIG. 21) is selected by the operator, the display control unit 31 of the communication terminal 30 transmits the workspace ID of the selected workspace (referred to as a “selected workspace” in the following description) to the information collection apparatus 10 as a selection result.

When the reception unit 121 of the information collection apparatus 10 receives the selection result (in S205 of FIG. 14), the candidate selection unit 128 executes a process (a selection process) to specify a group (that serves as a group as a candidate of an assignment destination for the first data) that has the highest degree of relevance to each piece of document information (that serves as the first data) to be registered among the groups (that serve as one or more groups into which a management unit relating to the workspace selected as the candidate is divided) belonging to the selected workspace (S206). Specifically, the candidate selection unit 128 executes the processing in FIG. 19 for each piece of document information to be registered and each group belonging to the selected workspace to calculate the degree of relevance between each piece of document information and each group belonging to the selected workspace. The candidate selection unit 128 selects a group that has the highest degree of semantic relevance or wording relevance for each piece of document information.

The display information generation unit 131 generates display information of a screen (referred to as a “preview screen” in the following description) that indicates the contents of a proposal relating to the assignment (classification) of the document information to be registered to a group in the selected workspace, based on the result of the process to specify a group (S207). The output unit 132 transmits the display information to the communication terminal 30 (S208). The display control unit 31 of the communication terminal 30 displays the preview screen based on the display information.

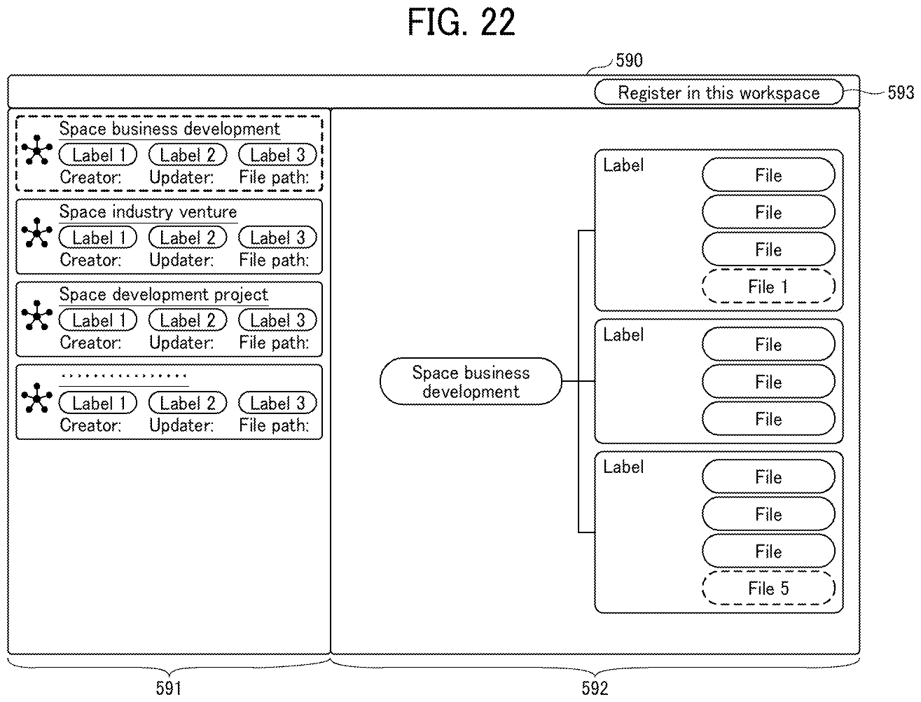

FIG. 22 is a diagram illustrating display of the preview screen in the case of registration in an existing workspace according to an embodiment of the present disclosure. As illustrated in FIG. 22, a preview screen 590 includes a list display area 591, a preview area 592, and a button 593.

The list display area 591 is an area in which a list of candidate workspaces is displayed. In the initial state, the workspace selected from the candidate workspaces is in the selected state. In the list display area 591 illustrated in FIG. 22, the candidate workspace whose frame line is a broken line is the selected workspace.

The preview area 592 is an area in which the contents of a proposal relating to the assignment of each piece of document information to be registered to a group in the selected workspace is displayed. More specifically, in the preview area 592, the structure of the selected workspace is presented in the form of a tree structure. In the tree structure, the root node corresponds to the selected workspace. Each child node (referred to as a “group node” in the following description) of the root node corresponds to each group belonging to the selected workspace. Each figure (a figure in which a character string “file” is included in FIG. 22) arranged in each group node corresponds to each piece of document information (document data) belonging to each group. The figure in which the character string “file” is included is referred to as a “document node” in the following description. Each document node whose frame line is a broken line (referred to as a “temporary document node” in the following description) corresponds to each piece of document information to be registered. Each temporary document node is arranged in the group node of the group selected in step S206 for the document information relating to each temporary document node. The position of each temporary document node in the preview area 592 is merely a proposal made by the candidate selection unit 128. The operator can change the position in which each temporary document node is arranged.

The operator can select another candidate workspace different from the selected workspace in the list display area 591. In this case, the processes of steps S205 to S208 are executed again for the newly selected workspace as the selected workspace. As a result, the preview screen 590 is displayed again in a state where the newly selected workspace is selected.

In the preview screen 590, the button 593 is a button for receiving an instruction to register the document information to be registered in the selected workspace. When the button 593 is pressed, the display control unit 31 transmits a registration request including the workspace ID of the selected workspace (referred to as a “registration workspace” in the following description) at the time when the button 593 is pressed to the information collection apparatus 10.

When the reception unit 121 of the information collection apparatus 10 receives the registration request (in S209 of FIG. 14), the display information generation unit 131 generates display information of a workspace edit screen based on the workspace ID included in the registration request and the document information to be registered (S210). The output unit 132 transmits the display information to the communication terminal 30 (S211). The display control unit 31 of the communication terminal 30 displays the workspace edit screen based on the display information.

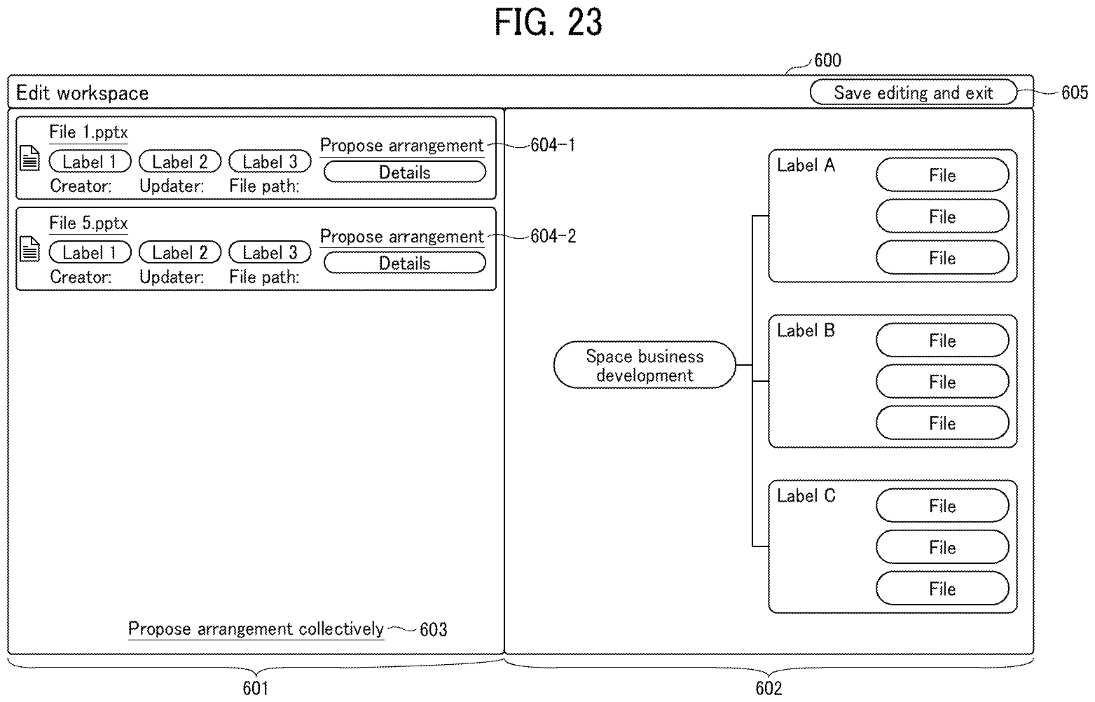

FIG. 23 is a diagram illustrating display of the workspace edit screen in the initial state when an existing workspace is a registration destination according to an embodiment of the present disclosure. As illustrated in FIG. 23, a workspace edit screen 600 includes a left frame 601, a right frame 602, a link 603, links 604-1 and 604-2, and a button 605. The links 604-1 and 604-2 are referred to as “links 604” when they are not distinguished from each other.

In the initial state, a list of the pieces of document information to be registered is displayed in the left frame 601. In the right frame 602, a structure of the registration workspace (i.e., a tree structure representing the structure of the workspace) is presented. The right frame 602 is an area in which the assignment state of each piece of document information to be registered to a group in accordance with an editing operation operated by the operator is displayed. In the right frame 602 in the initial state, no document information to be registered is arranged.

The link 603 is a link for receiving a request, toward the proposal from the information collection apparatus 10, regarding the assignment of each piece of document information to a group. When the link 603 is selected, the display control unit 31 changes the left frame 601 to an area for receiving selection of the assignment method to a group.

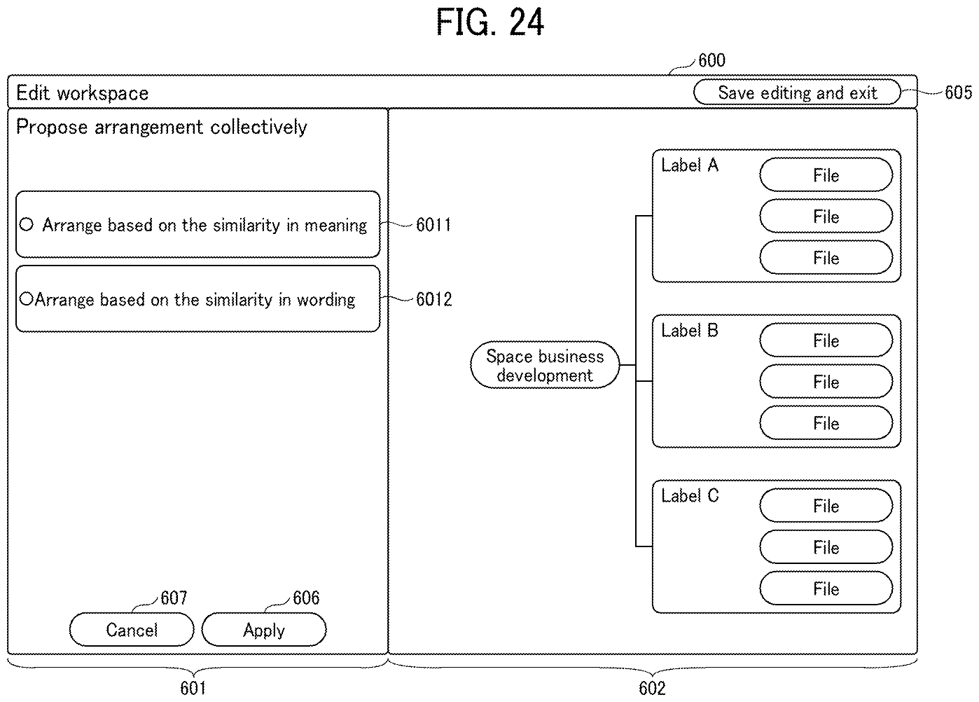

FIG. 24 is a diagram illustrating display of the workspace edit screen 600 for receiving selection of the assignment method to a group according to an embodiment of the present disclosure. As illustrated in FIG. 24, in the left frame 601, options 6011 and 6012 as options of the assignment method to a group are presented. The option 6011 is an option corresponding to a method of prioritizing a group that has a relatively high degree of semantic relevance (referred to as an “assignment method based on the degree of semantic relevance” in the following description) to the document data of each piece of document information as an assignment destination for each piece of document information. The option 6012 is an option corresponding to a method of prioritizing a group that has a relatively high degree of wording relevance (referred to as an “assignment method based on the degree of wording relevance” in the following description) to the document data of each piece of document information as an assignment destination for each piece of document information.

When one of the options is selected, the display control unit 31 of the communication terminal 30 transmits an assignment request according to the selected option to the information collection apparatus 10. When the reception unit 121 of the information collection apparatus 10 receives the assignment request, the candidate selection unit 128 executes the processing in FIG. 19 to specify, for each piece of document information to be registered, a group having the highest degree of relevance to the document data of the document information among the groups belonging to the registration workspace. At this time, in the case where the assignment method based on the degree of semantic relevance is selected, the degree of semantic relevance is calculated. In the case where the assignment method based on the degree of wording relevance is selected, the degree of wording relevance is calculated. In either case, one group is selected from the groups belonging to the registration workspace for each piece of document information to be registered. The output unit 132 transmits a response including the group label of the selected group to the communication terminal 30 for each piece of document information to be registered. The display control unit 31 of the communication terminal 30 updates the contents displayed in the right frame 602 on the workspace edit screen 600 based on the response.

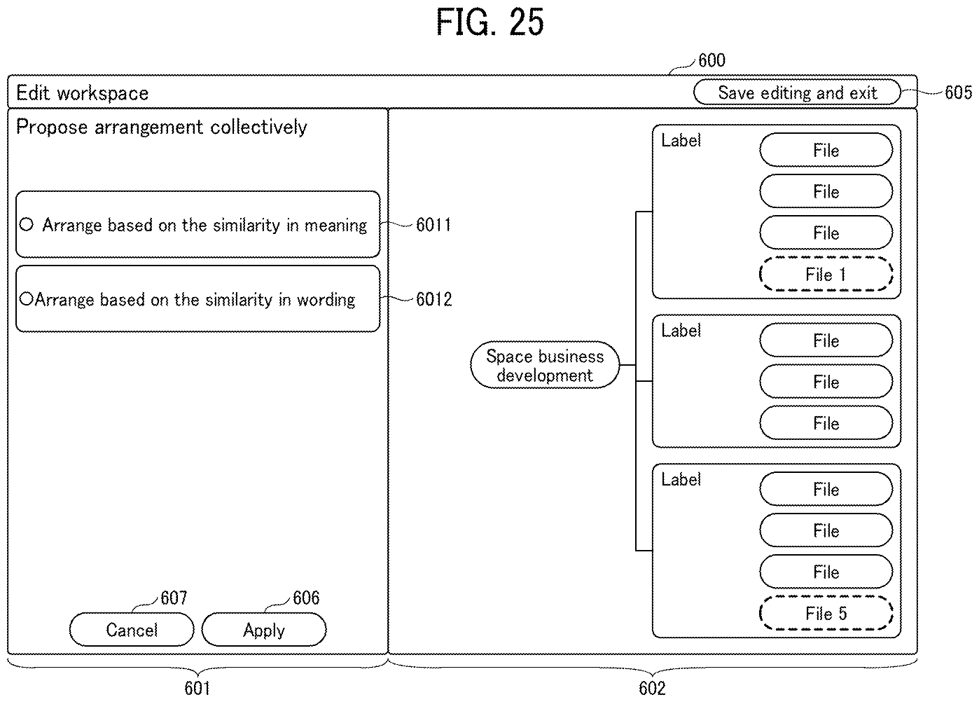

FIG. 25 is a diagram illustrating display of the workspace edit screen 600 presenting an assignment state for all the pieces of document information to be registered based on a proposal, according to an embodiment of the present disclosure. As illustrated in FIG. 25, one temporary document node is added to each of the group node at the top and the group node at the bottom in the right frame 602 on the workspace edit screen 600. In other words, it is proposed that the document information relating to a “file 1” is arranged in the group relating to the group node at the top, and the document information relating to a “file 5” is arranged in the group relating to the group node at the bottom.

The operator presses an apply button 606 to continue editing while the state displayed in the right frame 602 regarding the assignment destination for each piece of document information is maintained. In this case, the display control unit 31 of the communication terminal 30 returns the contents displayed in the left frame 601 on the workspace edit screen 600 to those in the initial state (see FIG. 23). At this time, the state in the right frame 602 is maintained. In other words, the right frame 602 is in a state where the temporary document nodes are arranged.

Alternatively, the operator may press a cancel button 607 to discard the state displayed in the right frame 602 regarding the assignment destination for each piece of document information and continue editing. In this case, the display control unit 31 of the communication terminal 30 returns both the left frame 601 and the right frame 602 on the workspace edit screen 600 to their initial states (see FIG. 23).

When one of the links 604 is selected in a situation where at least the left frame 601 on the workspace edit screen 600 is in the initial state (see FIG. 23), the display control unit 31 transmits a proposal request to propose an assignment destination including the document ID of the document information (referred to as “target document information” in the following description) relating to the selected link 604 to the information collection apparatus 10. The proposal request is a proposal request to propose an assignment destination for one piece of document information relating to the document ID. When the reception unit 121 of the information collection apparatus 10 receives the proposal request, the candidate selection unit 128 executes the processing in FIG. 19 for the target document information and each group belonging to the registration workspace to calculate the degree of semantic relevance and the degree of wording relevance between the target document information and each group. The candidate selection unit 128 specifies groups (each of which is referred to as a “relevant group” in the following description) whose degree of semantic relevance or degree of wording relevance is equal to or greater than the threshold value, and outputs information (referred to as “ground information” in the following description) indicating whether the groups are specified based on the degree of semantic relevance or the degree of wording relevance (which degree of relevance is equal to or greater than the threshold value) for each relevant group. When both degrees of relevance are equal to or greater than the threshold value, information indicating the degree of relevance having a larger value may be used as the ground information. The output unit 132 transmits the group label and the ground information of each relevant group to the communication terminal 30. The display control unit 31 of the communication terminal 30 updates the contents displayed in the left frame 601 on the workspace edit screen 600 based on the received information.

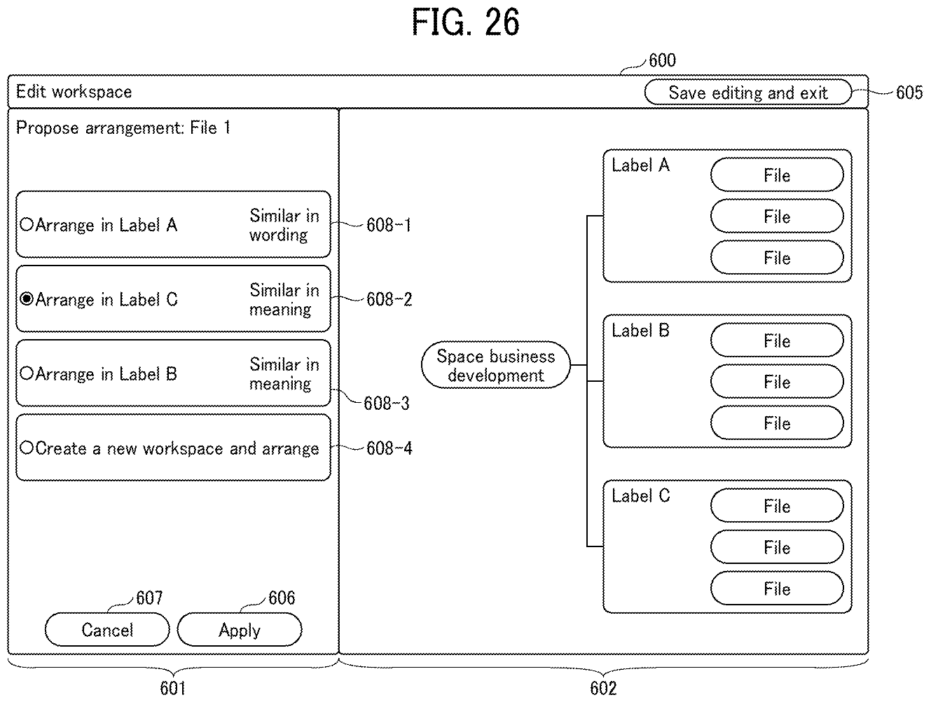

FIG. 26 is a diagram illustrating display of the workspace edit screen 600 presenting a proposal of an assignment destination for one piece of document information, according to an embodiment of the present disclosure. As illustrated in FIG. 26, in the left frame 601, options 608-1 to 608-4 are presented as candidates of the assignment destination for each target document information. Each of the options 608-1 to 608-3 is an option corresponding to a relevant group, and includes the group label of the corresponding relevant group and a character string based on the ground information indicating the ground for each group being selected as the relevant group. The character string indicates “Similar in meaning” in the case of being based on the degree of semantic relevance and “Similar in wording” in the case of being based on the degree of wording relevance. The option 608-4 is an option for newly generating a group (new group) in the registration workspace and setting the new group as the assignment destination for the target document information. In the case where there is no relevant group for the target document information (in the case where there is no group whose degree of relevance is equal to or greater than the threshold value), only the option 608-4 is displayed in the left frame 601.

When one of the options 608-1 to 608-3 is selected, the display control unit 31 updates the contents displayed in the right frame 602 as follows.

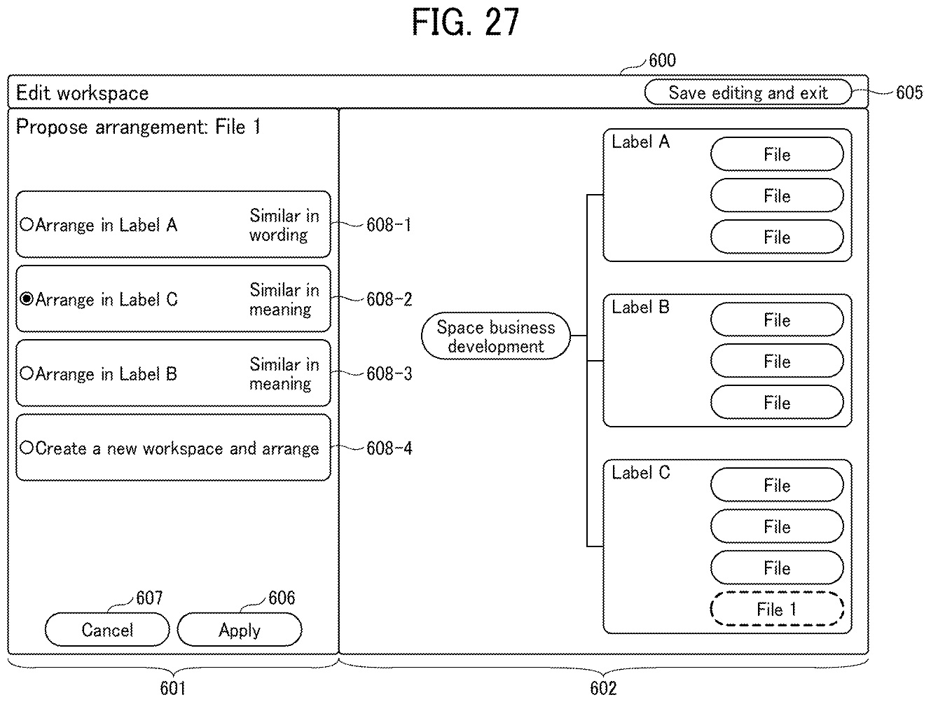

FIG. 27 is a diagram illustrating display of the workspace edit screen 600 updated when an option corresponding to a relevant group is selected, according to an embodiment of the present disclosure. In FIG. 27, a case in which the contents displayed in the right frame 602 are updated when the option 608-2 is selected is illustrated. In this case, the display control unit 31 adds a temporary document node corresponding to the target document information in the group node corresponding to the option 608-2.

Thereafter, when the operator presses the button 605, the display control unit 31 updates the contents displayed in the left frame 601 to the state illustrated in FIG. 23 while the state of the right frame 602 is maintained. By selecting the link 604-2 in FIG. 23, the operator can receive a proposal of relevant groups for the other document information, and can arrange the other document information in one of the relevant groups.

On the other hand, when the option 608-4 is selected on the workspace edit screen 600 in the state illustrated in FIG. 26, the display control unit 31 updates the contents displayed in the left frame 601 and the contents displayed in the right frame 602 as follows.

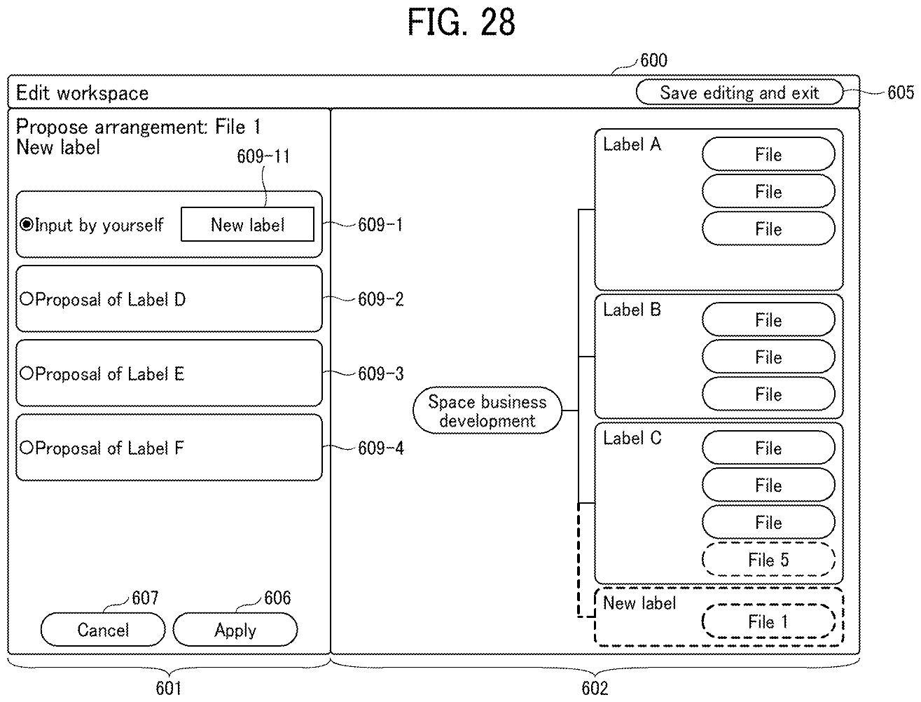

FIG. 28 is a diagram illustrating display of the workspace edit screen 600 updated when an option corresponding to a new group is selected, according to an embodiment of the present disclosure.

As illustrated in FIG. 28, when the option 608-4 is selected, the display control unit 31 adds a group node corresponding to the new group in the right frame 602, and adds a temporary document node corresponding to the target document information in the group node. The display control unit 31 also updates the contents displayed in the left frame 601 to include options 609-1 to 609-4 for selecting a group label for the new group. The option 609-1 is an option for allowing the operator to input the group label. The options 609-2 to 609-4 are options corresponding to the respective group labels proposed by the information collection apparatus 10. Regarding the group labels proposed by the information collection apparatus 10, the display control unit 31 may inquire of the information collection apparatus 10, for example, at the timing when the option 608-4 in FIG. 27 is selected (the timing when the contents displayed in the left frame 601 are updated). At this time, the display control unit 31 notifies the information collection apparatus 10 of the document ID of the target document information. The labeling unit 127 of the information collection apparatus 10 generates group labels that include some top words having a high value of TF-IDF among the words included in the document data corresponding to the document ID as candidates for the group label of the group to which the document information relating to the document data belongs. The output unit 132 transmits the candidates for the group label to the communication terminal 30. The display control unit 31 of the communication terminal 30 displays the options 609-2 to 609-4 based on the candidates for the group label.

When one of the options 609-2 to 609-4 is selected, the display control unit 31 displays a candidate for the group label corresponding to the selected option in the group node of the new group arranged in the right frame 602. This means that the candidate has been set as the group label of the new group.

When the option 609-1 is selected, the display control unit 31 displays the label input to a label input field 609-11 for the group node of the new group arranged in the right frame 602. This means that the label is set as the group label of the new group.

The assignment destination for the document information to be registered can be determined not only by the proposal made by the information collection apparatus 10 but also by the operator as desired.

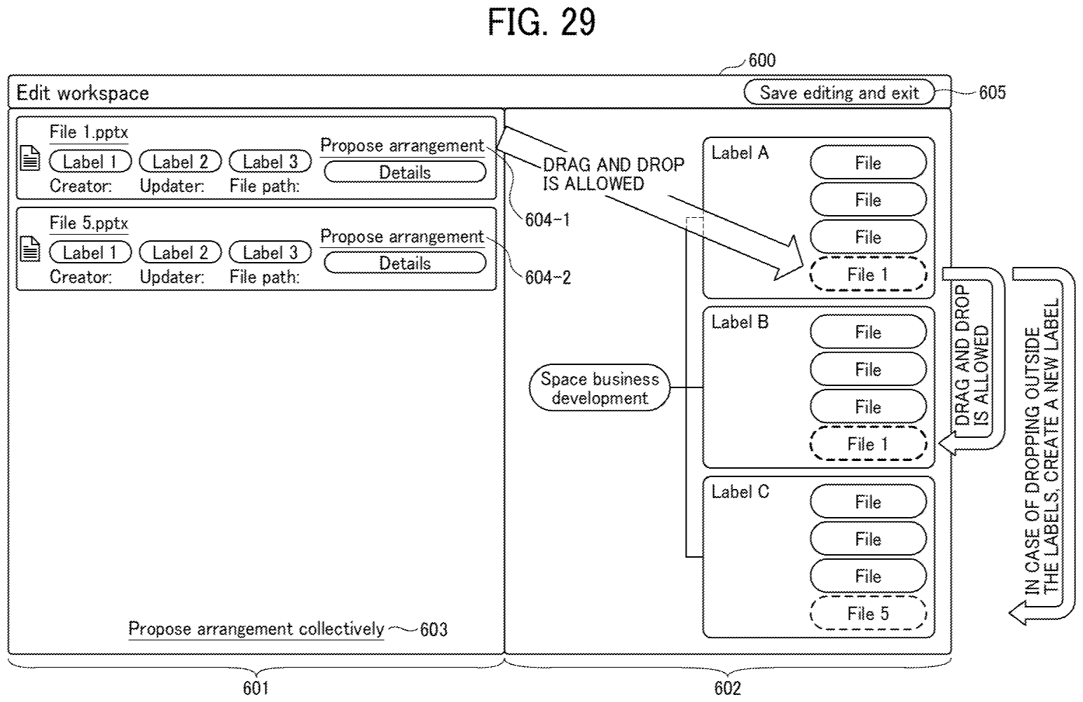

FIG. 29 is a diagram illustrating the case in which the assignment destination for the document information to be registered is determined by the operator as desired, according to an embodiment of the present disclosure. For example, the operator can drag and drop one of the pieces of document information displayed in the left frame 601 into one of the group nodes displayed in the right frame 602. In this case, the display control unit 31 displays the temporary document node of the one of the pieces of document information in the one of the group nodes. The operator can also move the temporary document node displayed in one of the group nodes in the right frame 602 to another group node by dragging and dropping. In this case, the display control unit 31 deletes the temporary document node in the group node from which the temporary document node has been dragged and displays the temporary document node in the other group node into which the temporary document node has been dropped.

In the case where the position where the one of the pieces of document information is dropped is outside all the group nodes in the right frame 602, the display control unit 31 generates a group node of a new group and displays the temporary document node of the dropped piece of document information in the group node of the new group. The display control unit 31 also displays options corresponding to candidates for the group label of the new group in the left frame 601 as illustrated in FIG. 28.

When the editing operation is completed and the button 605 is pressed, the display control unit 31 transmits the contents displayed in the right frame 602 at that time to the information collection apparatus 10 as an editing result. The editing result includes, for each piece of document information to be registered, the document ID of the document information and the group label of the group to which the document information is assigned, in addition to the workspace ID of the registration workspace.

When the reception unit 121 of the information collection apparatus 10 receives the editing result (YES in S212 of FIG. 14), the workspace editing unit 130 updates the contents stored in the workspace storage unit 23 (see FIG. 12) based on the editing result (S213). Specifically, in the case where the group label of the group included in the editing result, to which the document ID is assigned, is an existing “registration group label” in the workspace record corresponding to the registration workspace, the workspace editing unit 130 adds the document record corresponding to the document ID in the group record corresponding to the “registration group label.” The workspace editing unit 130 registers the document ID and the file path of the document data relating to the document ID as the “registration data ID” and the “registration data path” in the document record corresponding to the document ID, respectively.

On the other hand, specifically, in the case where the group label of the group included in the editing result, to which the document ID is assigned, is not an existing “registration group label” in the workspace record corresponding to the registration workspace, the workspace editing unit 130 adds a new group record in the workspace record and registers the group label as the “registration group label” in the new group record. The workspace editing unit 130 also adds a document record corresponding to the document ID in the new group record. The workspace editing unit 130 registers the document ID and the file path of the document data relating to the document ID as the “registration data ID” and the “registration data path” in the document record corresponding to the document ID, respectively.

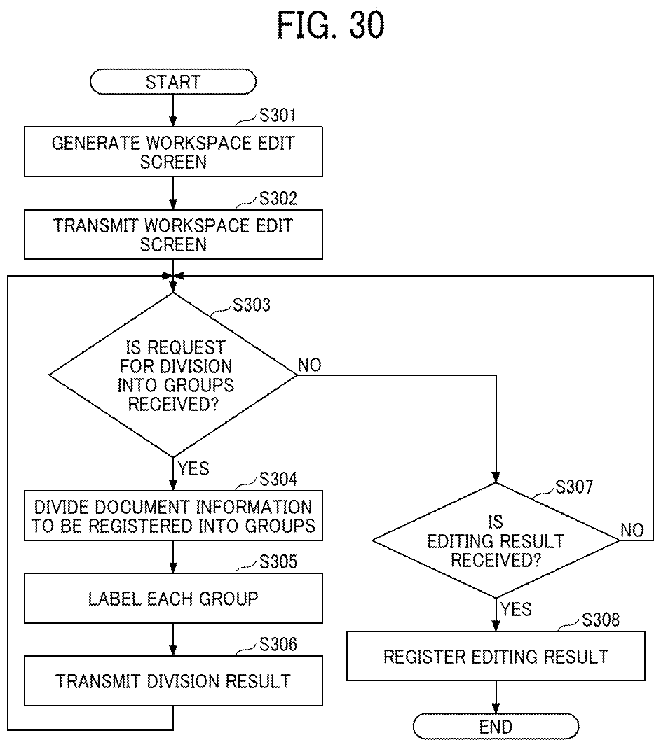

The process of step S113 in FIG. 4 is described below in detail. FIG. 30 is a flowchart of the processing for registration in a new workspace that is empty, according to an embodiment of the present disclosure.

In response to the registration request received by the reception unit 121 in step S109 of FIG. 4, the display information generation unit 131 generates display information of a workspace edit screen based on the document information to be registered relating to the document ID included in the registration request (S301). The output unit 132 transmits the display information to the communication terminal 30 (S302). The display control unit 31 of the communication terminal 30 displays the workspace edit screen based on the display information.

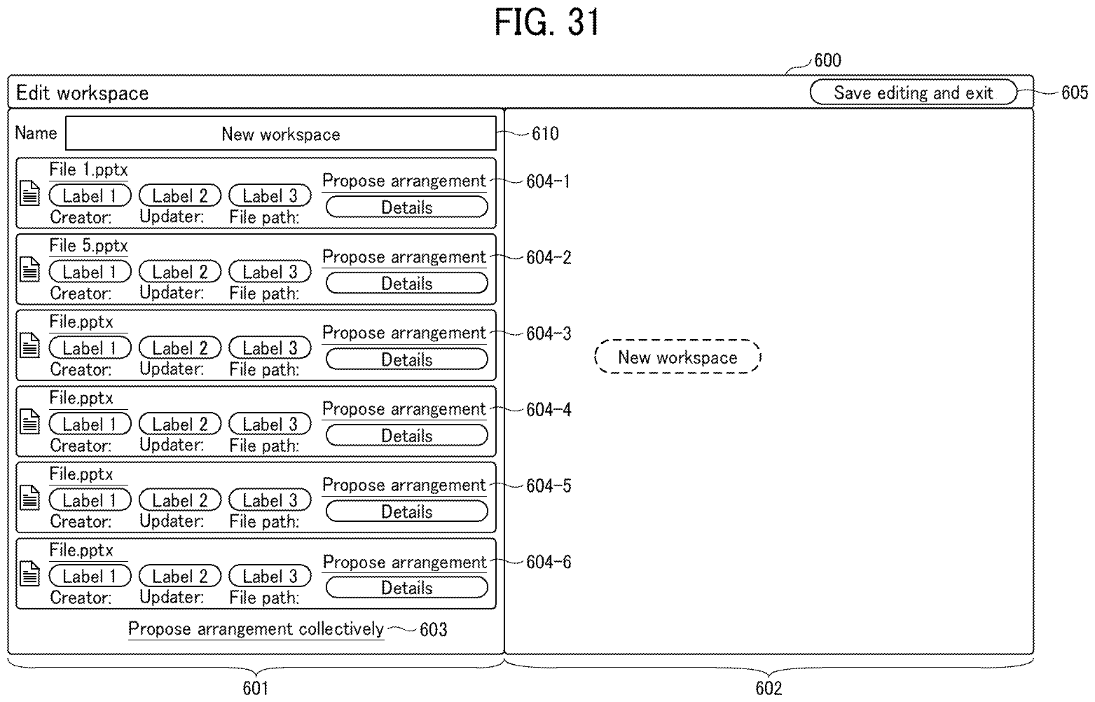

FIG. 31 is a diagram illustrating display of the workspace edit screen 600 in the initial state in the case of registration in a new workspace according to an embodiment of the present disclosure. In FIG. 31, like reference signs are allocated to the same components as or the components corresponding to those of FIG. 23, and the descriptions thereof are omitted as appropriate.

In the case where the registration destination is a new workspace, the structure of the workspace is unknown. Accordingly, in this case, unlike the case where the registration destination is an existing workspace (see FIG. 23), the structure of the workspace as the registration destination is not displayed in the right frame 602. In FIG. 31, a node representing an empty workspace (referred to as a “temporary workspace node” in the following description) is represented by a broken line in the right frame 602.

In the left frame 601, a list of pieces of document information to be registered is presented as in FIG. 23, and a workspace name input field 610 that is not presented in FIG. 23 is also presented. The workspace name input field 610 is a field for receiving an input of a workspace name for a new workspace. When a workspace name is input to the workspace name input field 610, the display control unit 31 displays the workspace name in the temporary workspace node displayed in the right frame 602. In FIG. 31, the list of the pieces of document information to be registered presented in the left frame 601 is different from that in FIG. 23. This is for the sake of convenience of explanation.

When the link 603 is selected, the display control unit 31 transmits a division request for dividing the pieces of document information to be registered into groups to the information collection apparatus 10. The division request includes the number of divisions. The initial value of the number of divisions may be determined, for example, based on the number of pieces of document information to be registered. For example, the initial value may be the maximum number of divisions (note that the number should be an integer of one or more) within the range of the condition that two or more pieces of document information belong to one group. The division request for division into groups is synonymous with an assignment request for assigning document information to a group to be newly generated.

When the reception unit 121 of the information collection apparatus 10 receives the division request (YES in S303 of FIG. 30), the classification unit 126 divides a document information group to be registered into groups of the number of divisions included in the division request (S304). For example, the classification unit 126 may divide the document information group into groups by clustering a document vector group relating to the document information group. The clustering may be performed using, for example, the k-means method or another method known in the art.

The labeling unit 127 attaches a group label to each group (S305). For example, for a collection of pieces of document data relating to pieces of document information belonging to a certain group, the labeling unit 127 may use, as a group label of the group, a character string formed based on one or more words determined to be relatively important by using, for example, TF-IDF. Alternatively, the labeling unit 127 may use one or more document labels that have a relatively high frequency of appearance in a list of document labels of pieces of document data belonging to a certain group as a group label of the group.

The output unit 132 transmits information including a list of group labels and the pieces of document information belonging to a group relating to each group label to the communication terminal 30 as a division result of division into groups (S306). The division result means a proposal made by the information collection apparatus 10 regarding the assignment of the pieces of document information to be registered to the groups.

The display control unit 31 of the communication terminal 30 updates the workspace edit screen 600 as follows based on the division result.

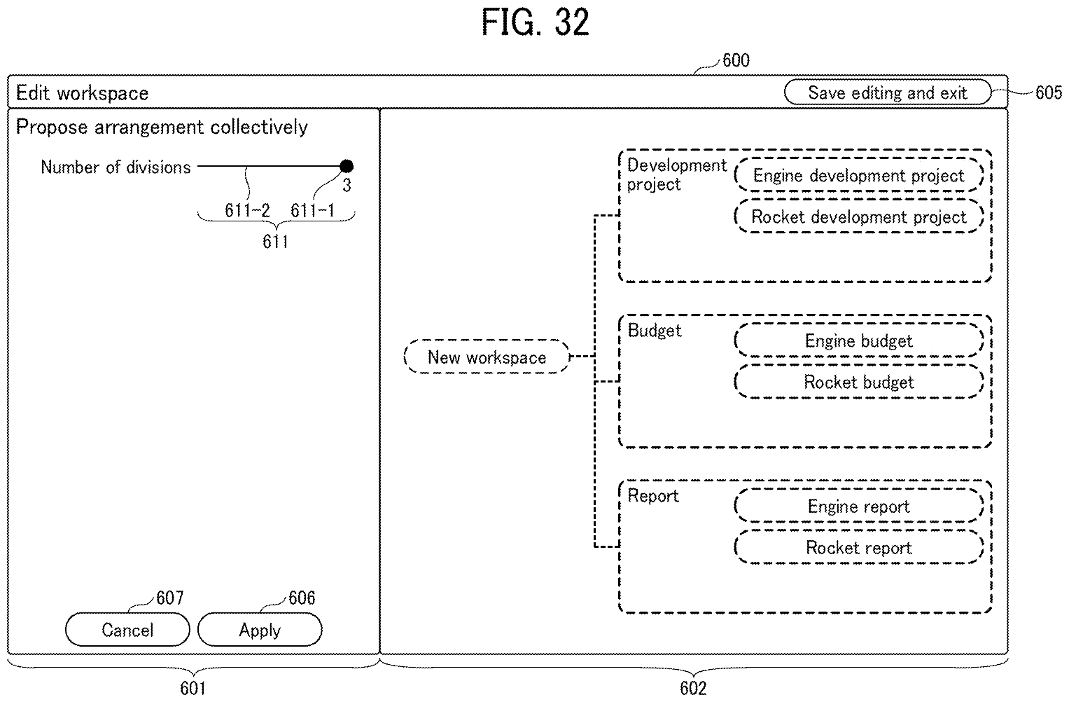

FIG. 32 is a diagram illustrating display of the workspace edit screen 600 presenting the result of the first division into groups according to an embodiment of the present disclosure. In the right frame 602 on the workspace edit screen 600 illustrated in FIG. 32, the division result is presented. In other words, in the right frame 602, the group node of each group generated by dividing the pieces of document information is displayed as a child node of the temporary workspace node, and the temporary document nodes relating to the pieces of document information classified into (assigned to) the group relating to each group node are arranged in each group node. At this point, the division into the groups is a temporary state. Accordingly, the group nodes are represented by broken lines. In the following description, a group node corresponding to a temporary group is referred to as a “temporary group node.”

In the left frame 601, a slider 611, an apply button 606, and a cancel button 607 are presented. The apply button 606 and the cancel button 607 are as described in, for example, FIG. 24.

The slider 611 is an operation component for receiving an instruction to change the number of divisions into groups. The operator can input an instruction to change the number of divisions by horizontally moving a knob 611-1 of the slider 611 along a bar 611-2. When the knob 611-1 is moved, the display control unit 31 transmits a division request including the number of divisions corresponding to the position to which the knob 611 has been moved to the information collection apparatus 10. In this case, the information collection apparatus 10 executes the processes of steps S304 to S306 in FIG. 30 again, and transmits the division result obtained based on the number of divisions to the communication terminal 30. The display control unit 31 of the communication terminal 30 updates the contents displayed in the right frame 602 on the workspace edit screen 600 based on the division result.

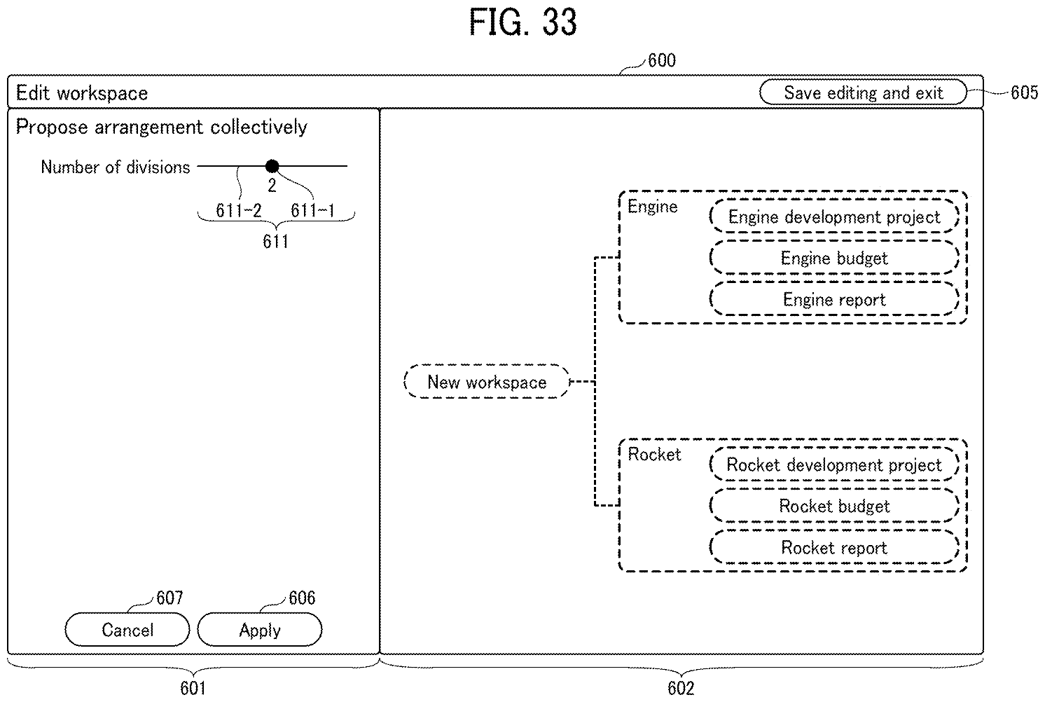

FIG. 33 is a diagram illustrating display of the workspace edit screen 600 presenting a result of the second division into groups according to an embodiment of the present disclosure. In FIG. 33, a case in which the contents displayed in the right frame 602 are updated when the number of divisions is designated to be two is illustrated. In this case, the number of the temporary group nodes matches the number of divisions after the change.

Even when the registration destination is a new workspace, the operator can determine, as desired, a group to which each piece of document information is to be assigned.

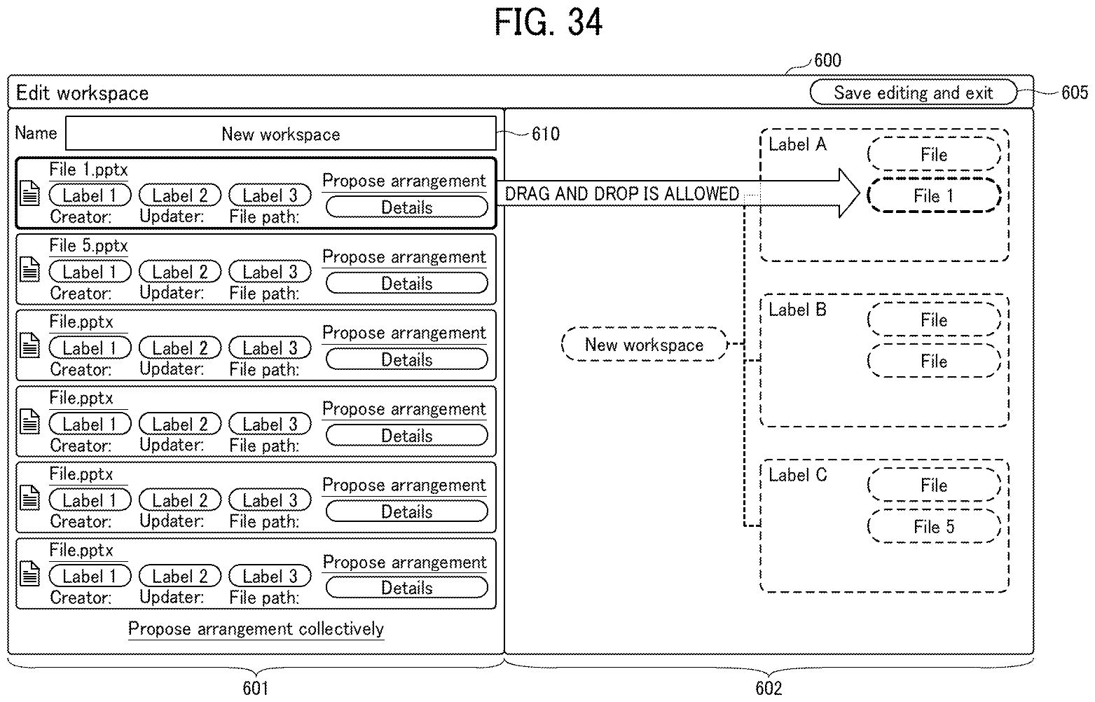

FIG. 34 is a diagram illustrating a case in which an assignment destination for the document information to be registered is determined by the operator as desired when the registration destination is a new workspace that is empty, according to an embodiment of the present disclosure. The contents displayed in the left frame 601 in FIG. 34 are the same as the contents displayed in the left frame 601 in FIG. 31.

The operation method of the workspace edit screen 600 illustrated in FIG. 34 is basically the same as the operation method described with reference to FIG. 29.

When document information is dropped into the right frame 602 in a state where there is no temporary group node or when the document information is dropped outside all the temporary group nodes, the display control unit 31 generates a temporary group node of a new group and displays the temporary document node of the document information in the temporary group node. On the other hand, when the document information is dropped into one of the temporary group nodes, the display control unit 31 displays the temporary document node of the document information in the one of the temporary group nodes. The workspace name of the temporary workspace node or the group label of the temporary group node may be editable when the temporary workspace node or the temporary group node is arranged in the right frame 602.

When the editing operation is completed and the button 605 is pressed, the display control unit 31 transmits the contents displayed in the right frame 602 at that time to the information collection apparatus 10 as an editing result. The editing result includes the workspace ID of the registration workspace, the workspace name of the temporary workspace node, and a list of the group labels of the temporary group nodes, and for each piece of document information to be registered, the document ID of the document information and the group label of the group to which the document information is assigned.

When the reception unit 121 of the information collection apparatus 10 receives the editing result (YES in S307 of FIG. 30), the workspace generation unit 129 updates the contents stored in the workspace storage unit 23 (see FIG. 12) based on the editing result (S308). Specifically, the workspace generation unit 129 adds a new workspace record in the workspace storage unit 23 (see FIG. 12), and assigns a workspace ID to the new workspace record by a predetermined method. The workspace generation unit 129 registers the workspace name, a label, and the creator included in the editing result in the new workspace record. The label may be generated based on a collection of words included in the document data of each piece of document information to be registered, in the same manner as the method of generating a group label. The employee ID of the login operator may be registered as the creator. The workspace generation unit 129 also generates, in the workspace record, a group record for each group label included in the editing result, and registers the group label as the “registration group label” of each group record. The workspace generation unit 129 further generates, in each group record, a document record for each piece of document information assigned to the group relating to each group record, and registers the document ID of each piece of document information and the file path of the document data relating to each document ID as the “registration data ID” and the “registration data path” of each piece of document record, respectively.

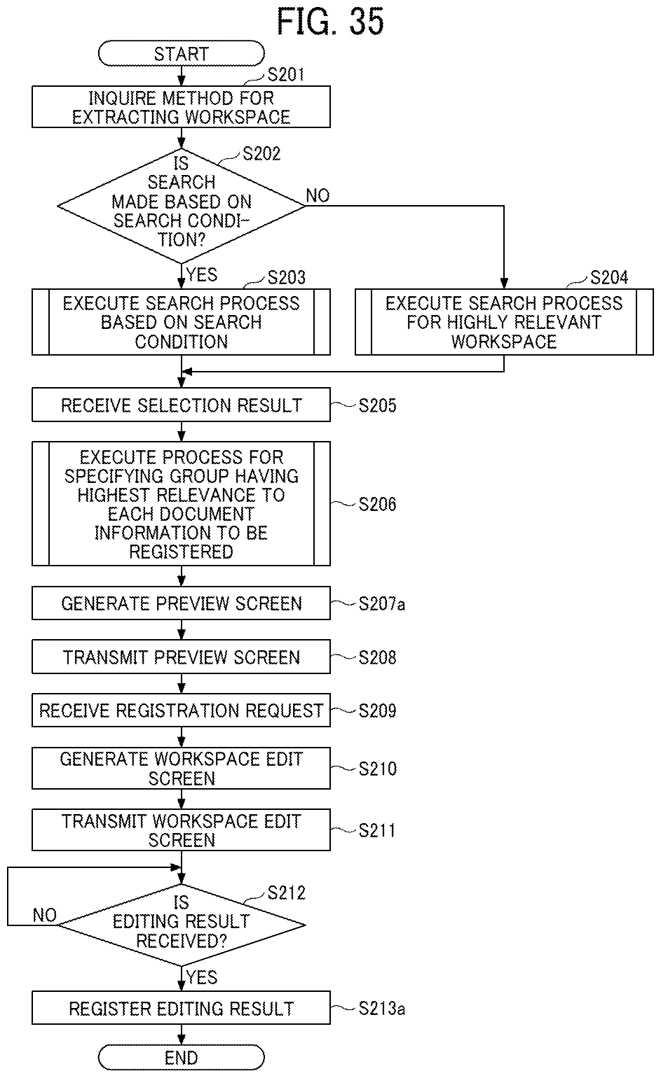

The process of step S115 in FIG. 4 is described below in detail. FIG. 35 is a flowchart of the processing for registration in a new workspace in which a group structure of an existing workspace is copied, according to an embodiment of the present disclosure. In FIG. 35, the same step numbers are allocated to the same processes as those in the flowchart of FIG. 14, and the descriptions thereof are omitted as appropriate. In FIG. 35, the processes of steps S207 and S213 in FIG. 14 are replaced by the processes of steps S207a and S213a, respectively.

In step S207a, the display information generation unit 131 generates display information of a preview screen presenting contents of a proposal regarding the assignment (classification) of the document information to be registered to a group in the selected workspace, based on the result of the process (in S206) of specifying the group having the highest degree of relevance to each piece of document information to be registered. At this time, the display information generation unit 131 sets the workspace node corresponding to the selected workspace as the temporary workspace node. This is because the workspace corresponding to the workspace node (temporary workspace node) corresponds not to the selected workspace but to a new workspace in which the group structure of the selected workspace is copied. The display information generation unit 131 does not include the pieces of document information belonging to each group of the selected workspace in the display information. The output unit 132 transmits the display information to the communication terminal 30 (S208). The display control unit 31 of the communication terminal 30 displays the preview screen based on the display information.

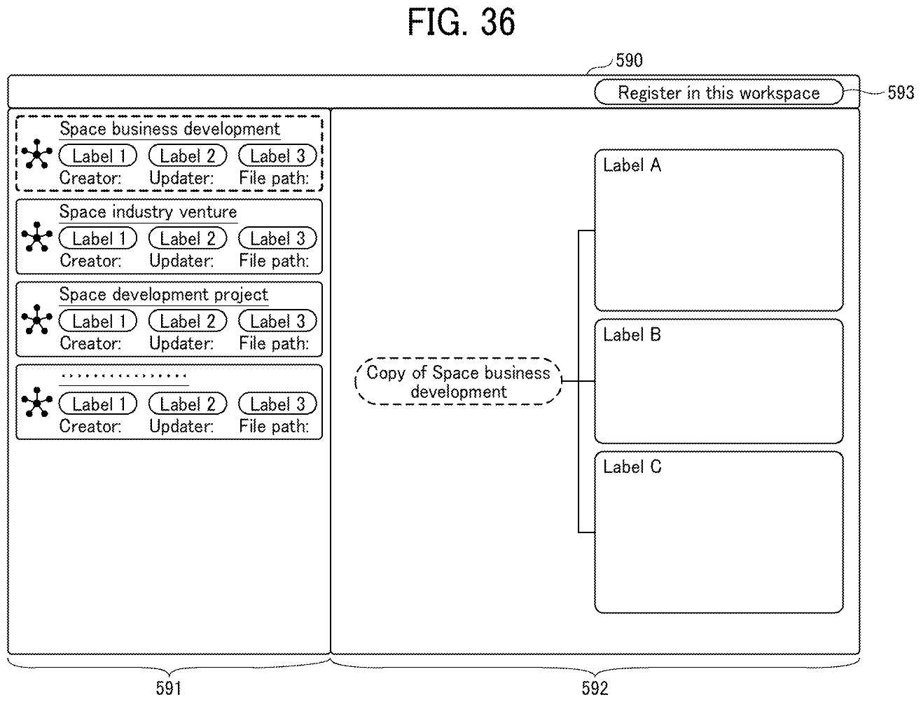

FIG. 36 is a diagram illustrating display of the preview screen 590 in the case of registration in a new workspace in which a group structure of an existing workspace is copied, according to an embodiment of the present disclosure. In FIG. 36, like reference signs are allocated to the same components as those of FIG. 22, and the descriptions thereof are omitted as appropriate.

On the preview screen 590 illustrated in FIG. 36, no document node is presented in the group nodes arranged in the preview area 592. This is because, in step S207a, the pieces of document information belonging to each group of the selected workspace are not included in the display information of the preview screen 590. In other words, in the processing in FIG. 35, the registration destination in which the pieces of document information are registered is not the existing workspace itself but a new workspace in which the group structure of the existing workspace is copied. Accordingly, in the initial state of the new workspace, there is no document information belonging to each group. As illustrated in FIG. 36, the initial setting of the workspace name of the temporary workspace node corresponding to the new workspace is a character string obtained by adding a character string “copy of” to the workspace name of the workspace that is the copy source. This is given by way of example, and another character string may be used as the initial setting of the workspace name of the temporary workspace node. On the other hand, the group label of the copy source is inherited as each group label of the new workspace.

The operation method of the preview screen 590 is basically the same as that described with reference to FIG. 22. However, the configuration of the workspace edit screen 600 displayed when the button 593 is pressed is different from that in FIG. 23.

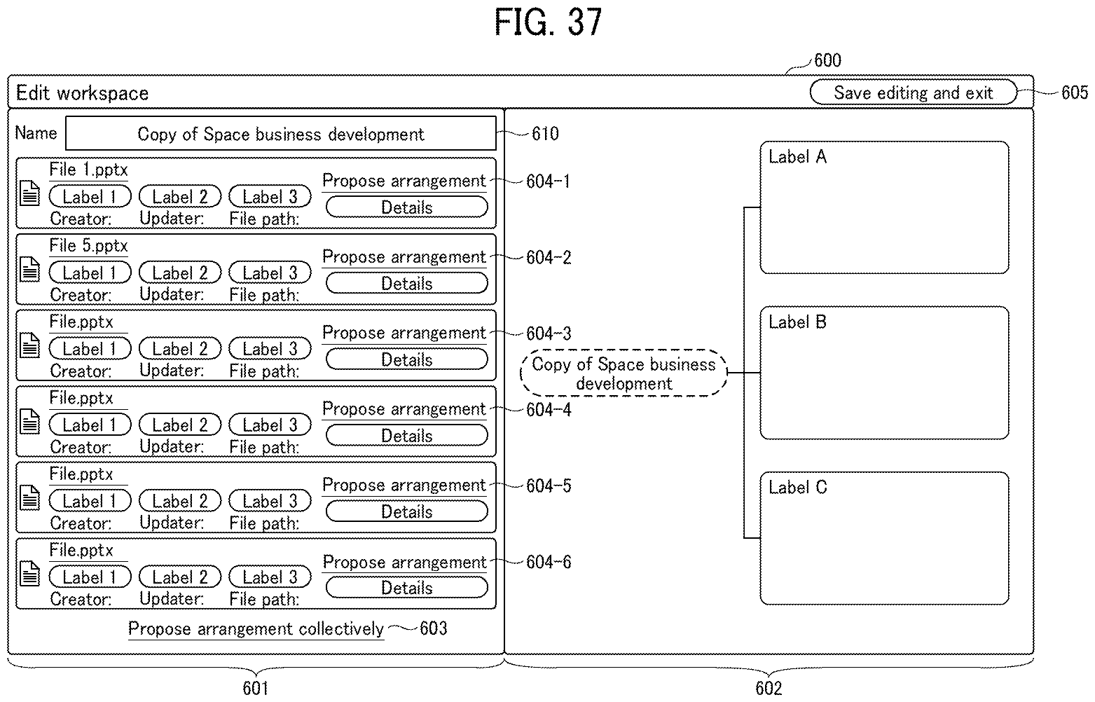

FIG. 37 is a diagram illustrating display of the workspace edit screen 600 in the initial state when a new workspace in which a group structure of an existing workspace is copied is a registration destination, according to an embodiment of the present disclosure. In FIG. 37, like reference signs are allocated to the same components as those of FIG. 31, and the descriptions thereof are omitted as appropriate. As illustrated in FIG. 37, the contents displayed in the left frame 601 in the initial state on the workspace edit screen 600 when a new workspace in which the group structure of an existing workspace is copied is the registration destination are the same as those illustrated in FIG. 31 (i.e., when the registration destination is a new workspace that is empty). In FIG. 37, the list of the pieces of document information to be registered presented in the left frame 601 is different from that in FIG. 23. This is for the sake of convenience of explanation.

On the other hand, in the right frame 602 illustrated in FIG. 37, the group structure of the selected workspace (referred to as a “copy source workspace” in the following description) is presented.

The method of inputting the workspace name for the new workspace and the method of assigning the document information to each group of the new workspace are as described above. When the editing operation is completed and the button 605 is pressed, the display control unit 31 transmits the contents displayed in the right frame 602 at that time to the information collection apparatus 10 as an editing result. The editing result includes the workspace name of the temporary workspace node, a list of group labels of each group node, and for each piece of document information to be registered, the document ID of the document information and the group label of the group to which the document information is assigned.

When the reception unit 121 of the information collection apparatus 10 receives the editing result (YES in S212 of FIG. 35), the workspace generation unit 129 executes the same process as that of S308 in FIG. 30 based on the editing result (S213a). As a result, a workspace record of the new workspace in which the group structure of the copy source workspace is copied is added to the contents stored in the workspace storage unit 23 (see FIG. 12).

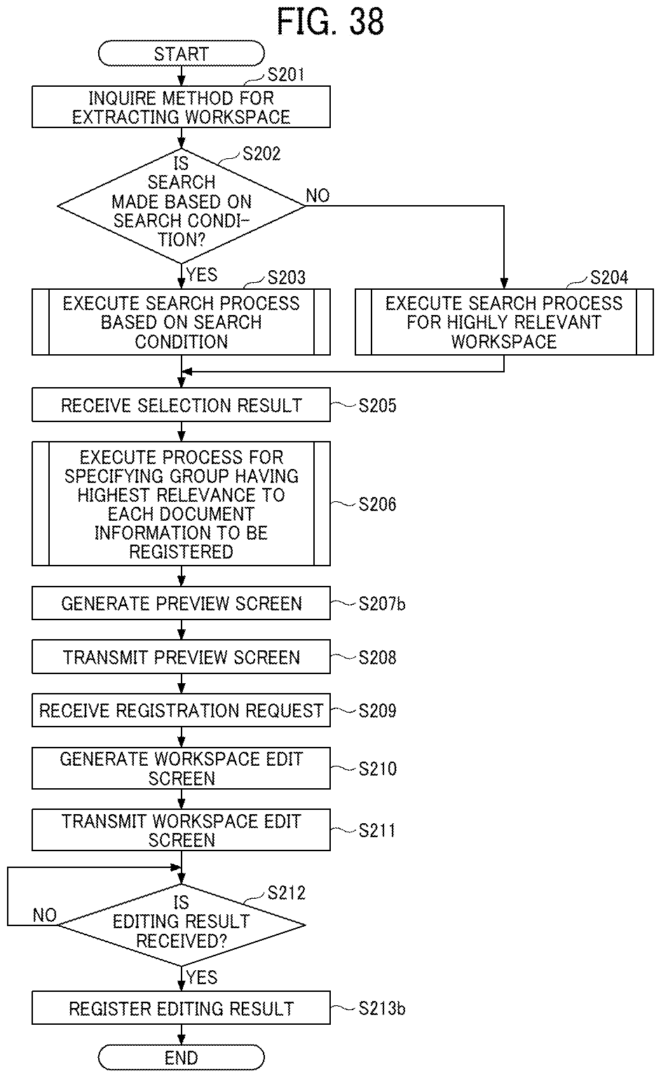

The process of step S116 in FIG. 4 is described below in detail. FIG. 38 is a flowchart of the processing for registration in a new workspace in which all of an existing workspace is copied, according to an embodiment of the present disclosure.

In FIG. 38, the same step numbers are allocated to the same processes as those in the flowchart of FIG. 14, and the descriptions thereof are omitted as appropriate. In FIG. 38, the processes of steps S207 and S213 in FIG. 14 are replaced by the processes of steps S207b and S213b, respectively.

In step S207b, the display information generation unit 131 generates display information of a preview screen presenting contents of a proposal regarding the assignment (classification) of the document information to be registered to a group in the selected workspace, based on the result of the process (in S206) of specifying the group having the highest degree of relevance to each piece of document information to be registered. At this time, the display information generation unit 131 sets the workspace node corresponding to the selected workspace as the temporary workspace node. The other operations in step S207b are the same as those in step S207. The output unit 132 transmits the display information to the communication terminal 30 (S208). The display control unit 31 of the communication terminal 30 displays the preview screen based on the display information.

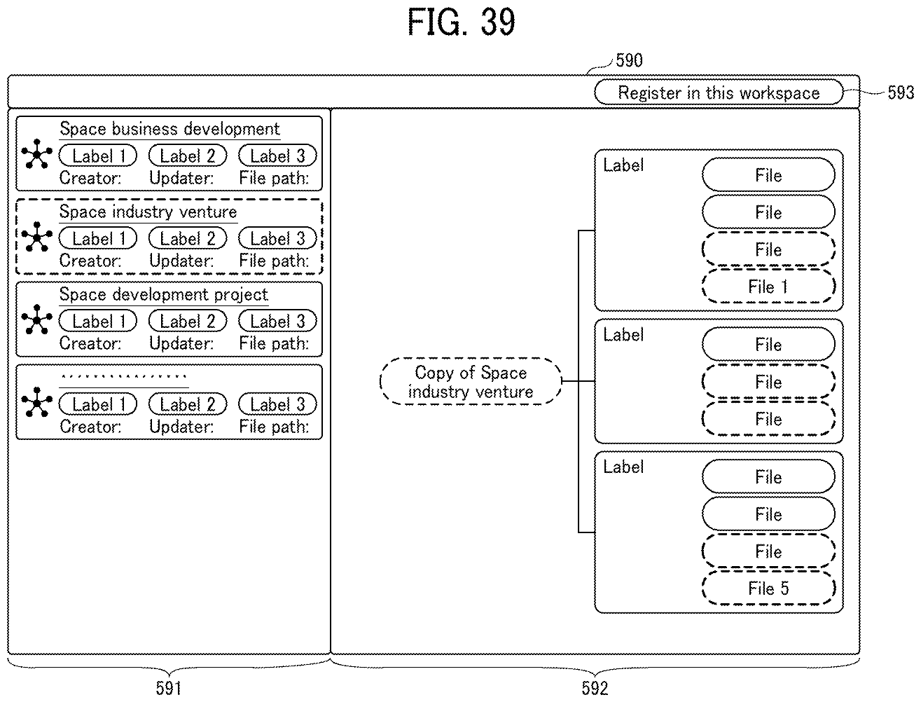

FIG. 39 is a diagram illustrating display of the preview screen 590 in the case of registration in a new workspace in which all of an existing workspace is copied, according to an embodiment of the present disclosure. In FIG. 39, for the sake of convenience, a case based on a situation in which the second workspace from the top in the left frame 601 is the selected workspace and there are six pieces of document information to be registered. In addition to the differences arisen based on such a situation, the preview screen 590 in FIG. 39 basically differs from that in FIG. 22 in that the workspace node presented in the right frame 602 is a temporary workspace node.

The operation method of the preview screen 590 is basically the same as that described with reference to FIG. 22. However, the configuration of the workspace edit screen 600 displayed when the button 593 is pressed is different from that in FIG. 23.

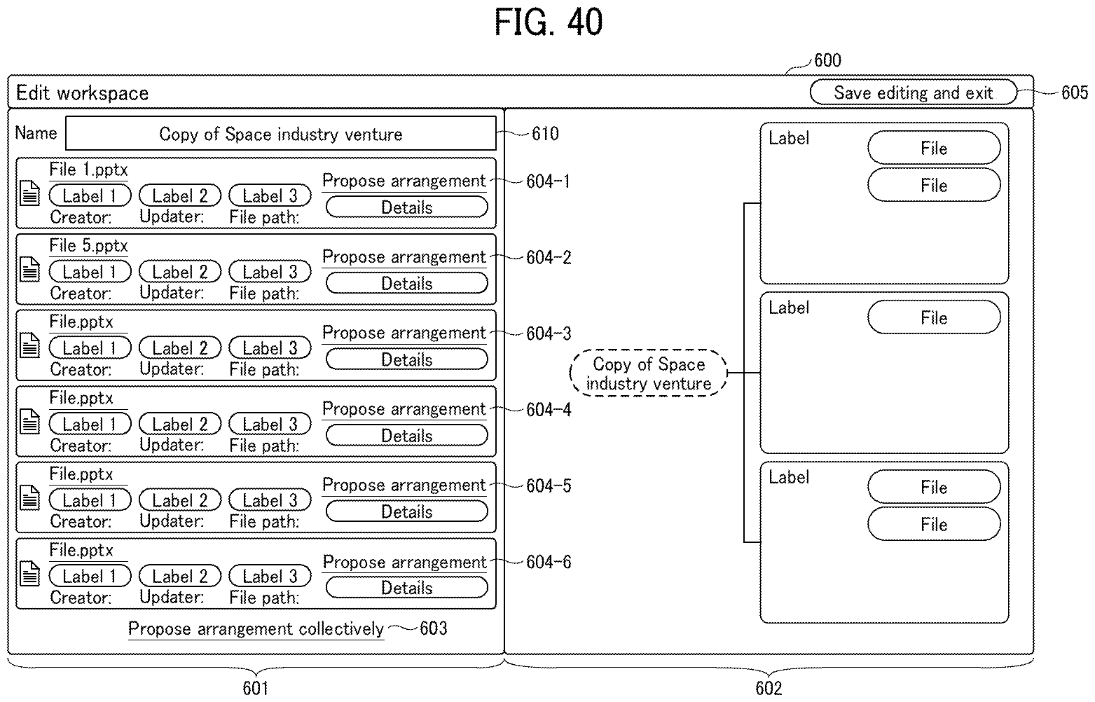

FIG. 40 is a diagram illustrating display of the workspace edit screen 600 in the initial state when a new workspace in which all of an existing workspace is copied is a registration destination, according to an embodiment of the present disclosure. As illustrated in FIG. 40, in the left frame 601 on the workspace edit screen 600 in the case where a new workspace in which all of an existing workspace is copied is the registration destination, the workspace name input field 610 is presented as in FIGS. 31 and 37. On the other hand, in the right frame 602, the structure of the copy source workspace is presented in the form of a tree structure.

The method of inputting the workspace name for the new workspace and the method of assigning the document information to each group of the new workspace are as described above. When the editing operation is completed and the button 605 is pressed, the display control unit 31 transmits the contents displayed in the right frame 602 at that time to the information collection apparatus 10 as an editing result. The editing result includes the workspace ID of the copy source workspace, the workspace name of the temporary workspace node, a list of group labels of each group node, and for each piece of document information to be registered and each piece of document information copied from the copy source workspace, the document ID of the document information and the group label of the group to which the document information is assigned.

When the reception unit 121 of the information collection apparatus 10 receives the editing result (YES in S212 of FIG. 38), the workspace generation unit 129 executes the same process as that of S308 in FIG. 30 based on the editing result (S213b). At this time, the workspace generation unit 129 may copy the label and the query stored in the workspace record of the copy source workspace to the label and the query of the new workspace. As a result, a workspace record of the new workspace in which all of the copy source workspace is copied is added to the contents stored in the workspace storage unit 23 (see FIG. 12).

As described above, according to the first embodiment, the information collection apparatus 10 generates a proposal of a workspace to be a registration destination and a group to be an assignment destination for the document information collected by the operator. The operator can determine the workspace to be the registration destination and the group to be the assignment destination based on the proposal, and can also adopt the proposal as it is. As a result, the workload used for the classification of the data is reduced.

The second embodiment is described below. In the second embodiment, the features different from the first embodiment are described. Accordingly, the features that are not particularly mentioned are substantially the same as those of the first embodiment.

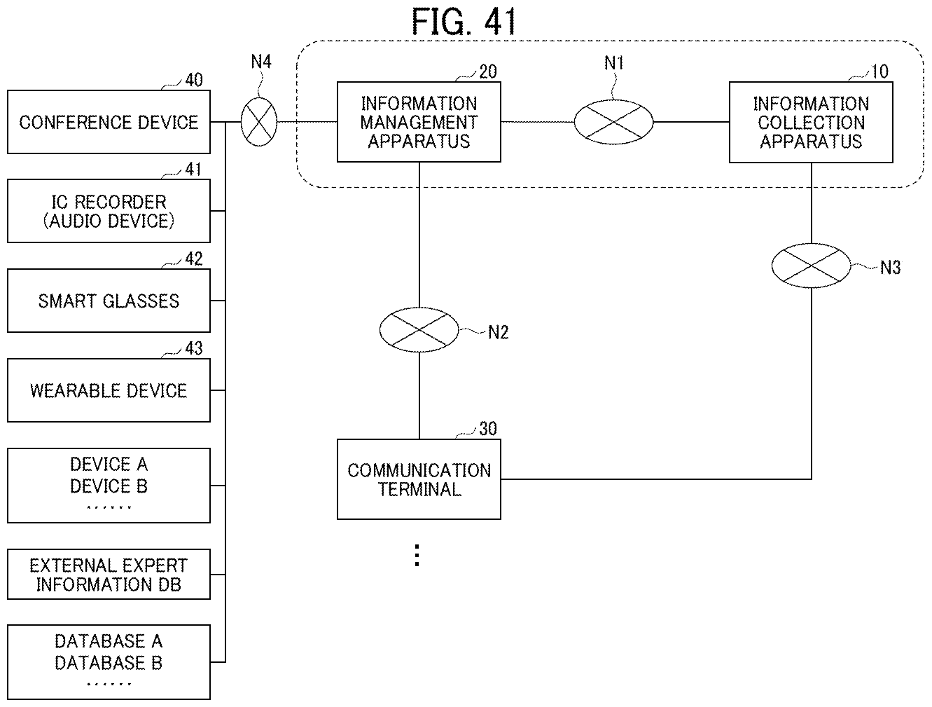

FIG. 41 is a diagram illustrating a configuration of an information collection system according to the second embodiment of the present disclosure. In FIG. 41, like reference signs are allocated to the same components as those of FIG. 1, and the descriptions thereof are omitted as appropriate.

As illustrated in FIG. 41, a conference device 40 is connected to the information management apparatus 20 via a network N4. The conference device 40 is a device or a computer used for a remote conference such as a video conference or a web conference. For example, the conference device 40 may be an information processing apparatus that includes a camera and a microphone and is installed in, for example, a conference room. Alternatively, the conference device 40 may be another information processing apparatus (a server computer) connected to the above-describe information processing apparatus via a network. The conference device 40 manages information on the remote conference (referred to as “conference information” in the following description). The information management apparatus 20 acquires and stores the conference information managed by the conference device 40.

In addition to the conference device 40, various devices and systems (e.g., devices A and B) that use a certain service (function) or various external databases (e.g., databases A and B) such as an external intellectual information database (DB) may be connected to the information management apparatus 20 via the network N4. Examples of the devices and systems include, but not limited to, an audio device used for recording audio such as an integrated circuit (IC) recorder 41, a device for storing video data viewed by eyes such as smart glasses 42, and a recording device such as a wearable device 43. Examples of the external intellectual information DB include, but not limited to, a database storing information of experts in various fields such as doctors and lawyers, and a database storing information of intellectuals in various fields such as scholars and university professors. Thus, as in the case of the conference device 40, useful information stored in the various systems or the various databases connected to this information collection system can be collected.

In the present embodiment, the conference device 40 is given by way of example.

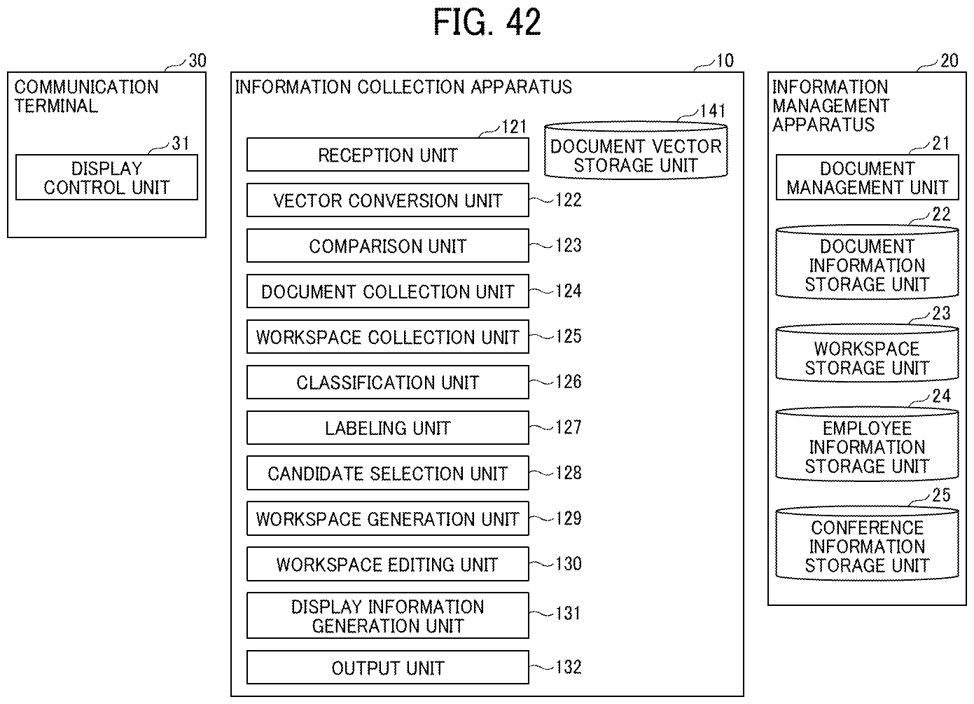

FIG. 42 is a block diagram illustrating a functional configuration of the information collection system according to the second embodiment of the present disclosure. In FIG. 42, like reference signs are allocated to the same components as those of FIG. 3, and the descriptions thereof are omitted as appropriate.

As illustrated in FIG. 42, the information management apparatus 20 further uses an employee information storage unit 24 and a conference information storage unit 25. Each of these storage units is implemented by using, for example, an auxiliary storage device of the information management apparatus 20 or a storage device connectable to the information management apparatus 20 via a network.

The employee information storage unit 24 stores, for example, attribute information (referred to as “employee information” in the following description) on each employee of the company X in which the information management apparatus 20 is used.

The conference information storage unit 25 stores, for each conference held in the company X, information (referred to as “conference information” in the following description) on the conference. The conference information may be acquired from the conference device 40, as described above.

In the second embodiment, the employee information and the conference information are used in the evaluation of the degree of relevance between document information (document data) and a workspace. In the following description, a case in which both employee information and conference information are used is described, but only one of them may be used in another embodiment.

Specifically, the processing in FIG. 18 is changed as follows.

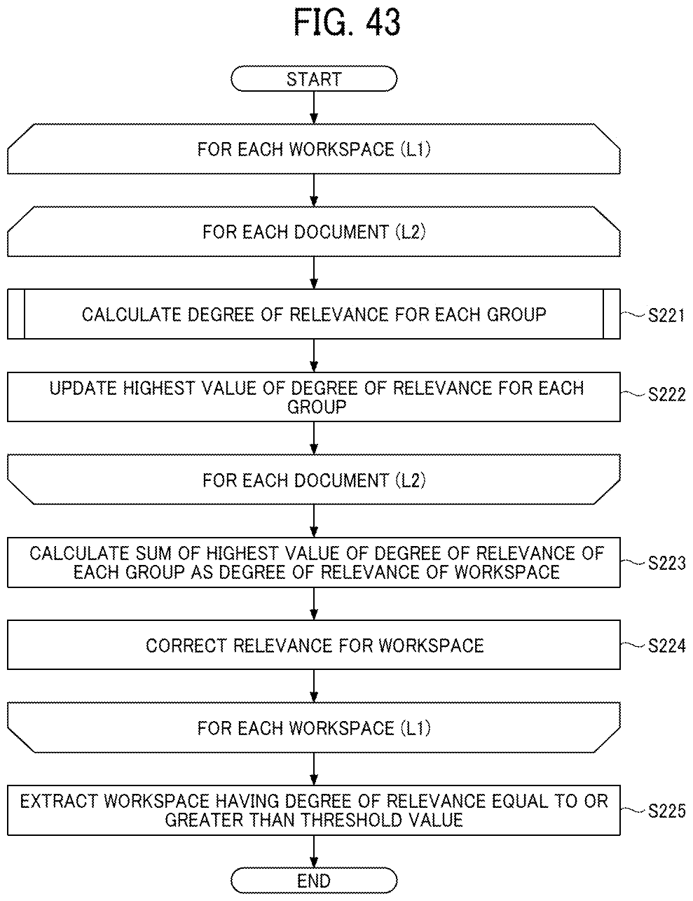

FIG. 43 is a flowchart of the processing to search for a relevant workspace according to the second embodiment of the present disclosure. In FIG. 43, the same step numbers are allocated to the same processes as those in the flowchart of FIG. 18, and the descriptions thereof are omitted as appropriate. In FIG. 43, the process of step S224 is added after the process of step S223 in the loop processing L1.

In step S224, the candidate selection unit 128 corrects the degree of relevance for the target workspace and selects some workspaces based on the degree of relevance between the login operator and each of a plurality of workspaces. The login operator in this case is an operator who requests registration of the collected document information (that serves as the first data) in one of the workspaces (that serves as the management unit). Specifically, when the department to which the login operator belongs and the department to which the creator or the updater of the target workspace belongs are the same department, the candidate selection unit 128 adds a predetermined value to the degree of relevance for the target workspace. The departments to which the login operator and the creator or the updater of the target workspace belong can be specified by referring to the contents stored in the employee information storage unit 24.

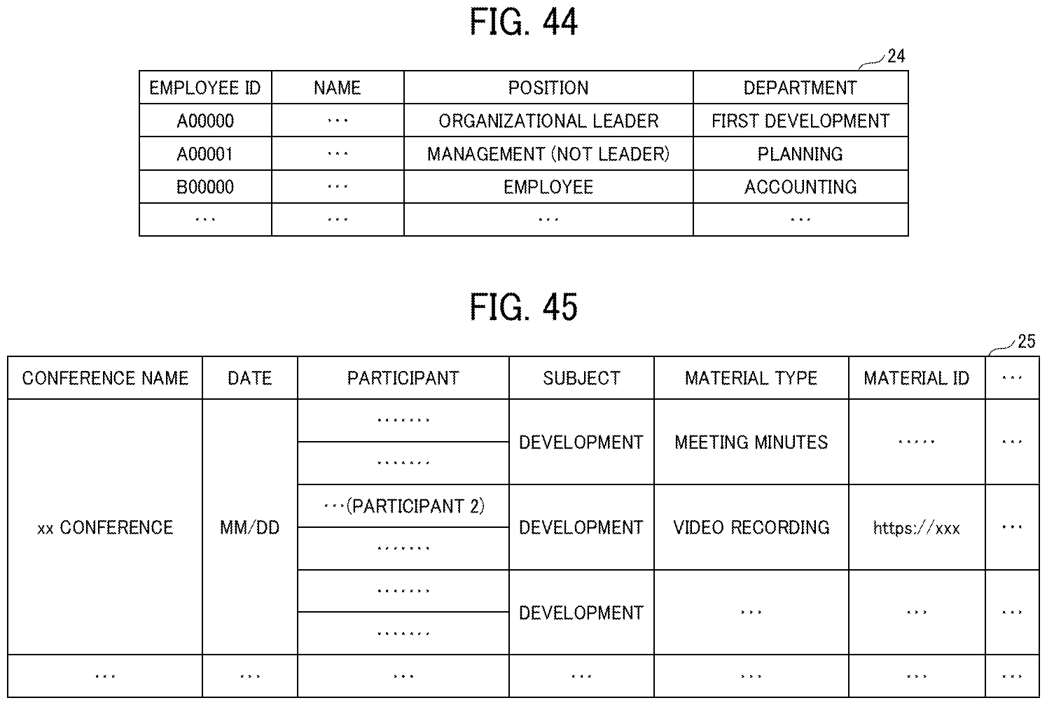

FIG. 44 is a diagram illustrating the structure of the employee information storage unit 24 according to an embodiment of the present disclosure. As illustrated in FIG. 44, the employee information storage unit 24 stores employee information such as an employee ID, a name, a position, and a department to which the employee belongs for each employee of the company X. The candidate selection unit 128 compares the department corresponding to the employee ID of the login operator with the department corresponding to the creator or the updater of the target workspace (see FIG. 12). When both departments are the same, the candidate selection unit 128 adds the predetermined value to the degree of relevance for the target workspace.

In this way, the possibility that a workspace having a relatively high degree of relevance to the login operator (for example, relevance to the job of the login operator) is extracted in step S225 is increased.

Alternatively, in step S224, the candidate selection unit 128 may select some workspaces based on the degree of relevance between a conference held in an organization to which the login operator belongs and each of the workspaces. The login operator in this case is an operator who requests registration of the document information (that serves as the first data) to be registered in one of the workspaces (that serves as the management unit). Specifically, the candidate selection unit 128 may correct the degree of relevance for the target workspace based on the degree of relevance between the target workspace and each conference held in the company X. For example, in the case where the degree of similarity between the workspace name of the target workspace (see FIG. 12) and one of the conference names of the conferences is equal to or greater than a threshold value, the candidate selection unit 128 may add a predetermined value to the degree of relevance for the target workspace. The conference name of each conference held in the company X can be specified by referring to, for example, the contents stored in the conference information storage unit 25.

FIG. 45 is a diagram illustrating the structure of the conference information storage unit 25 according to an embodiment of the present disclosure. As illustrated in FIG. 45, the conference information storage unit 25 stores a conference name, a date, and participants for each conference held in the company X, and stores, for example, a material type and a material ID for each material relating to each conference (used in the conference).

The conference name is the name of the conference. The date is the date on which the conference has been held. The participant is an employee ID of each employee (including the organizer of the conference) who has participated in the conference. The material type is a type of each material relating to the conference. Examples of the material type include a “handout,” “meeting minutes,” “video recording,” and “audio recording.” The “handout” is document data of a material distributed for the conference. The “meeting minutes” are document data of minutes of the conference. The “video recording” is video data in which the scenes (video) of the conference is recorded. The “audio recording” is audio data in which the scenes (audio) of the conference is recorded. The material ID is identification information of each material relating to the conference. Since a material whose material type is the “handout” or the “meeting minutes” is document data, the document ID of the document data is used as the material ID. In other words, the document information of this document data is also stored in the document information storage unit 22. On the other hand, regarding a material whose material type is the “video recording” or the “audio recording,” the uniform resource locator (URL) of the storage location where the video data or the audio data is stored may be used as the material ID. Alternatively, in the case where the document data includes both video data and audio data, the document information of the material whose material type is the “video recording” or the “audio recording” may also be stored in the document information storage unit 22. In this case, the material ID of the data of the material whose material type is the “video recording” or the “audio recording” may also be used as the document ID.

The degree of similarity between the workspace name and the conference name may be calculated by converting each of the workspace name and the conference name into a vector using natural language processing such as BERT. For example, the degree of cosine similarity of the vectors may be used as the degree of similarity between the workspace name and the conference name. The candidate selection unit 128 may limit the conferences for which the degree of similarity is calculated to the conferences that include the login operator as a participant.

The candidate selection unit 128 may add the predetermined value to the degree of relevance for the target workspace when the document information belonging to any group of the target workspace is a material of any conference or a conference that includes the login operator as a participant. The case where the document information belonging to any group of the target workspace is a material of any conference or a conference that includes the login operator as a participant is a case where the document ID of the document information belonging to any group of the target workspace matches the material ID of the conference.

By correcting the degree of relevance for the target workspace based on the degree of relevance to the conference, the possibility that a workspace having a relatively high degree of relevance to the job of the login operator is extracted in step S225 is increased.

In the second embodiment, when the document information group to be registered is divided into groups of the number of divisions included in the division request in step S304 of FIG. 30, the document information group to be registered may be divided into groups not based on the document vector but based on the degree of relevance to the login operator or another attribute of the document information.

As the first case, the classification unit 126 may classify the document information group (that serves as a plurality of pieces of the second data) to be registered into a plurality of groups based on whether the organization to which each piece of the document information group (that serves as the pieces of the second data) to be registered relates and the organization to which the login operator belongs are the same organization. The login operator in this case is an operator who requests registration of the document information group to be registered in one of the workspaces (that serves as the management unit). For example, the classification unit 126 may divide the document information group to be registered into two groups. One of the groups is a group in which the department to which the creator belongs (the organization to which the creator belongs) and the department to which the login operator belongs are the same department. The other of the groups is a group in which the department to which the creator belongs and the department to which the login operator belongs are different departments. The department to which the creator of the document information belongs and the department to which the login operator belongs can be specified by referring to the contents stored in the employee information storage unit 24 (see FIG. 44).

As the second case, the classification unit 126 may classify the document information group (that serves as the pieces of the second data) to be registered into a plurality of groups based on the organization to which each piece of the document information group (that serves as the pieces of the second data) to be registered relates. For example, the classification unit 126 may classify the document information group to be registered into groups according to the department to which the creator belongs.

As the third case, the classification unit 126 may classify the document information group (that serves as the pieces of the second data) to be registered into a plurality of groups based on the conference to which each piece of the document information group (that serves as the pieces of the second data) to be registered relates. For example, in the case where the document information group to be registered is a material of a conference (in the case where the document information group relates to the material ID included in the conference information (see FIG. 45)), the classification unit 126 may classify the document information group to be registered into groups according to the “subject” included in the conference information.

In the first to third cases described above, the number of groups after division may not match the designated number of divisions. In view of the above, when any one of the first to third cases is adopted, the number of divisions may not be allowed to be designated. In the case where the number of divisions is allowed to be designated, the classification unit 126 may perform the integration or division of groups, for example, in accordance with the magnitude relationship between the number of groups (simply referred to as “the number of groups” in the following description) obtained by dividing the document information group according to one of the first to third cases and the designated number of divisions (simply referred to as “the number of divisions” in the following description) as follows.

In the case where the number of groups is smaller than the number of divisions, the classification unit 126 recursively executes a process of selecting a group to which the largest number of pieces of document information belongs from the groups and dividing the document information group belonging to the selected group into two groups based on the document vector until the number of groups matches the number of divisions.

In the case where the number of groups is greater than the number of divisions, the classification unit 126 recursively executes a process of selecting a group to which the smallest number of document information belongs and integrating the selected group into the group most similar to the selected group until the number of groups matches the number of divisions. The degree of similarity between groups may be evaluated based on the degree of similarity of the document vector of the document information belonging to the groups. For example, the degree of similarity may be calculated based on the document vector for all pairs of pieces of document information between two groups, and the largest value or the average value of the degrees of similarity obtained by the calculation may be set as the degree of similarity between the two groups.

In the above description, the case in which the document data serves as data to be classified. Alternatively, data in another format (for example, image data or audio data) may be applied to the above embodiments. In this case, as the feature amount of the data in the format, an index corresponding to the characteristic of the data in the other format may be adopted.

The system for increasing the efficiency of access to data (collection of information) describe above may be utilized for the purpose of saving time for the operator to create new value through more creative work or increasing the opportunity for the operator to concentrate.

Each function of the embodiments of the present disclosure described above may be implemented by one processing circuit or a plurality of processing circuits. The “processing circuit or circuitry” herein includes a programmed processor to execute functions by software, such as a processor implemented by an electronic circuit, and devices, such as an application specific integrated circuit (ASIC), a digital signal processor (DSP), a field programmable gate array (FPGA), and circuit modules known in the art arranged to perform the recited functions.

In the above embodiments, the information collection apparatus 10 serves as an information processing apparatus or an information collection system.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Aspects of the present disclosure are, for example, as follows.

### Aspect 1

An information processing apparatus includes a candidate selection unit that selects, based on the feature amount of the first data and the feature amounts of one or more pieces of data belonging to each of a plurality of management units, some of the management units as candidates for a registration destination in which the first data is to be registered, and an output unit that outputs information indicating the candidates for the registration destination.

### Aspect 2

In the information processing apparatus according to Aspect 1, the candidate selection unit selects, based on the feature amount of data belonging to one or more groups divided from a management unit relating to a candidate selected from the candidates indicated by the information output by the output unit and the feature amount of the first data, a group as a candidate for an assignment destination to which the first data is to be assigned, and the output unit outputs information indicating the candidate for the assignment destination.

### Aspect 3

The information processing apparatus according to Aspect 1 or 2 includes a classification unit that classifies a plurality of pieces of the second data into a plurality of groups based on the feature amount of each piece of the second data, and a generation unit that newly generates a management unit in which the pieces of the second data are to be registered and divides the newly generated management unit into the groups classified by the classification unit.

### Aspect 4

In the information processing apparatus according to any one of Aspects 1 to 3, the candidate selection unit selects, based on the feature amount of data belonging to the groups divided from the management unit relating to the candidate selected from the candidates indicated by the information output by the output unit and the feature amount of the first data, a group as a candidate for an assignment destination to which the first data is to be assigned in the newly generated management unit divided into the same groups as those of the management unit, and the output unit outputs information indicating the candidate for the assignment destination.

### Aspect 5

In the information processing apparatus according to any one of Aspects 1 to 4, the candidate selection unit selects, based on the feature amount of the data belonging to the groups divided from the management unit relating to the candidate selected from the candidates indicated by the information output by the output unit and the feature amount of the first data, a group as a candidate for an assignment destination to which the first data is to be assigned in the newly generated management unit to which the same pieces of data as those of the management unit belong and which is divided into the same groups as those of the management unit, and the output unit outputs information indicating the candidate for the assignment destination.

### Aspect 6

In the information processing apparatus according to any one of Aspect 1 to 5, the candidate selection unit further selects the some of the management units based on the degree of relevance between an operator who requests registration of the first data in one of the management units and each of the management units.

### Aspect 7

In the information processing apparatus according to any one of Aspect 1 to 5, the candidate selection unit further selects the some of the management units based on the degree of relevance between a conference held in an organization to which an operator who requests registration of the first data in one of the management units belongs and each of the management units.

### Aspect 8

The information processing apparatus according to Aspect 1 or 2 incudes a classification unit that classifies the pieces of the second data into a plurality of groups based on a determination indicating whether an organization to which each piece of the second data relates and an organization to which an operator who requests registration of the pieces of the second data in one of the management units belongs are the same organization, and a generation unit that newly generates a management unit in which the pieces of the second data are to be registered and divides the newly generated management unit into the groups classified by the classification unit.

### Aspect 9

The information processing apparatus according to Aspect 1 or 2 includes a classification unit that classifies the pieces of the second data into a plurality of groups based on an organization to which each piece of the second data relates, and a generation unit that newly generates a management unit in which the pieces of the second data are to be registered and divides the newly generated management unit into the groups classified by the classification unit.

### Aspect 10

The information processing apparatus according to Aspect 1 or 2 includes a classification unit that classifies the pieces of the second data into a plurality of groups based on a conference to which each piece of the second data relates, and a generation unit that newly generates a management unit in which the pieces of the second data are to be registered and divides the newly generated management unit into the groups classified by the classification unit.

### Aspect 11

In the information processing apparatus according to any one of Aspects 1 to 10, the management unit is a collection of one or more pieces of the data, which is generated when the one or more pieces of the data are classified based on the commonality of input information.

### Aspect 12

In the information processing apparatus according to Aspect 2, the group is formed by dividing a collection of one or more pieces of the data belonging to the management units based on the degree of similarity of the feature amounts of the one or more pieces of the data.

### Aspect 13

An information processing system includes a candidate selection unit that selects, based on the feature amount of the first data and the feature amounts of one or more pieces of data belonging to each of a plurality of management units, some of the management units as candidates for a registration destination in which the first data is to be registered, and an output unit that outputs information indicating the candidates for the registration destination.

### Aspect 14

An information processing method includes selecting, based on the feature amount of the first data and the feature amounts of one or more pieces of data belonging to each of a plurality of management units, some of the management units as candidates for a registration destination in which the first data is to be registered, and outputting information indicating the candidates for the registration destination.

### Aspect 15

A non-transitory recording medium storing a plurality of program codes which, when executed by one or more processors, causes the one or more processors to perform a method that includes selecting, based on the feature amount of the first data and the feature amounts of one or more pieces of data belonging to each of a plurality of management units, some of the management units as candidates for a registration destination in which the first data is to be registered, and outputting information indicating the candidates for the registration destination.

Processors are considered processing circuitry or circuitry as they include transistors and other circuitry therein. In the disclosure, the circuitry, units, or means are hardware that carries out or is programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus comprising circuitry configured to:
select one or more of a plurality of management units as candidates for a registration destination in which first data is to be registered, based on a feature amount of the first data and feature amounts of data belonging to each of the plurality of management units; and
output information indicating the candidates for the registration destination.

2. The information processing apparatus according to claim 1, wherein the circuitry is further configured to:
select a group as a candidate for an assignment destination to which the first data is to be assigned, based on the feature amount of the first data and a feature amount of data belonging to one or more groups divided from a selected management unit, the selected management unit being one of the management units having been selected as the candidates and indicated by the information; and
output information indicating the candidate for the assignment destination.

3. The information processing apparatus according to claim 1, wherein the circuitry is configured to:
classify second data into a plurality of groups based on the feature amount of the second data; and
newly generate a management unit in which the second data is to be registered and divide the newly generated management unit into the plurality of groups.

4. The information processing apparatus according to claim 1, wherein the circuitry is configured to:
select a group as a candidate for an assignment destination to which the first data is to be assigned, the group being one of a plurality of groups divided from a management unit that is newly generated and having same groups as groups of a selected management unit that is one of the management units having been selected as the candidates and indicated by the information, based on the feature amount of the first data and a feature amount of data belonging to the groups divided from the selected management unit; and
output information indicating the candidate for the assignment destination.

5. The information processing apparatus according to claim 1, wherein the circuitry is configured to:
select a group as a candidate for an assignment destination to which the first data is to be assigned, the group being one of a plurality of groups divided from a management unit that is newly generated and having same data and same groups as data and groups of a selected management unit that is one of the management units having been selected as the candidates and indicated by the information, based on the feature of the first data and a feature amount of data belonging to the groups divided from the selected management unit; and
output information indicating the candidate for the assignment destination.

6. The information processing apparatus according to claim 1, wherein the circuitry is further configured to select the one or more of the plurality of management units based on a degree of relevance between a user who requests registration of the first data in one of the plurality of management units and each of the plurality of management units.

7. The information processing apparatus according to claim 1, wherein the circuitry is further configured to select the one or more of the plurality of management units based on a degree of relevance between a conference held in an organization to which a user who requests registration of the first data in one of the plurality of management units belongs and each of the plurality of management units.

8. The information processing apparatus according to claim 1, wherein the circuitry is configured to:
classify second data into a plurality of groups based on a determination indicating whether an organization to which the second data relates and an organization to which a user who requests registration of the second data in one of the plurality of management units belongs are a same organization;
newly generate a management unit in which the second data is to be registered; and
divide the newly generated management unit into the plurality of groups.

9. The information processing apparatus according to claim 1, wherein the circuitry is configured to:
classify second data into a plurality of groups based on an organization to which the second data relates;
newly generate a management unit in which the second data is to be registered; and
divide the newly generated management unit into the plurality of groups.

10. The information processing apparatus according to claim 1, wherein the circuitry is configured to:
classify second data into a plurality of groups based on a conference to which the second data relates;
newly generate a management unit in which the second data is to be registered; and
divide the newly generated management unit into the plurality of groups.

11. The information processing apparatus according to claim 1, wherein each of the plurality of the management units is a collection of one or more pieces of the data, which is generated when the one or more pieces of the data are classified based on commonality of input information.

12. The information processing apparatus according to claim 2, wherein the group is formed by dividing a collection of one or more pieces of the data belonging to the plurality of management units based on a degree of similarity of the feature amounts of the one or more pieces of the data.

13. An information processing system comprising circuitry configured to:
select one or more of a plurality of management units as candidates for a registration destination in which first data is to be registered, based on a feature amount of the first data and feature amounts of data belonging to each of the plurality of management units; and
output information indicating the candidates for the registration destination.

14. An information processing method comprising:
selecting one or more of a plurality of management units as candidates for a registration destination in which first data is to be registered based on a feature amount of the first data and feature amounts of data belonging to each of the plurality of management units; and
outputting information indicating the candidates for the registration destination.

15. A non-transitory recording medium storing a plurality of program codes which, when executed by one or more processors, causes the one or more processors to perform the method according to claim 14.
